(19) United States
(12) Patent Application Publication
(10) Pub. No.: US 2022/0204870 A1
(43) Pub. Date: Jun. 30, 2022

(54) CATALYTIC CRACKING PROCESS FOR A TRUE CIRCULAR SOLUTION FOR CONVERTING PYROLYSIS OIL PRODUCED FROM RECYCLED WASTE PLASTIC INTO VIRGIN OLEFINS AND PETROCHEMICAL INTERMEDIATES

(71) Applicant: LUMMUS TECHNOLOGY LLC, Bloomfield, NJ (US)

(72) Inventors: Joaquim Antonio de Oliveira Portela, Spring, TX (US); Rama Rao Marri, Katy, TX (US); Willibrord A. Groten, Houston, TX (US)

(73) Assignee: LUMMUS TECHNOLOGY LLC, Bloomfield, NJ (US)

(21) Appl. No.: 17/495,259

(22) Filed: Oct. 6, 2021

Related U.S. Application Data
(60) Provisional application No. 63/131,484, filed on Dec. 29, 2020.

(51) Int. Cl. C10G 51/04; C10G 11/05; C10G 29/16; C10B 53/07

(52) U.S. Cl. CPC C10G 51/04; C10G 11/05; C10G 29/16; C10G 2300/205; C10G 2300/70; C10G 2300/4081; C10B 53/07

(57) ABSTRACT

Processes and systems for producing raw materials and for producing truly circular polymers. The systems and processes may include processing a waste-derived hydrocarbon stream, such as a waste plastic pyrolysis oil, in a first reactor system with a catalyst mixture, and processing a fossil-based feedstock in a second reactor system with the catalyst mixture. The catalyst mixture may be supplied to each of the first and second reactor systems from a common catalyst regenerator. An effluent comprising fossil-based hydrocarbon products may be recovered from the second reactor system, and an effluent comprising waste-derived hydrocarbon products may be recovered from the first reactor system. Following separations, spent catalyst from each of the first and second reactor systems may be returned to the common catalyst regenerator.

### FIELD OF THE DISCLOSURE

Embodiments of the present disclosure generally relate to recycling waste materials, such as plastic waste. More specifically, embodiments herein relate to systems and processes providing a truly circular solution for returning end of useful life plastic materials back into olefins and chemical intermediates that may be useful in producing new plastic materials and compositions.

### BACKGROUND

Thermal pyrolysis of waste plastics reclaims valuable carbon and hydrogen elements from used plastics by converting them into valuable molecules that can become upgraded to new chemical intermediates and from them, converted into brand new consumer materials. Because of the potential that this process offers to repeatedly recycle post-use plastics into new materials, polymers produced through this process are referred to as circular polymers. This results in less plastic waste in landfills and the environment and replaces the consumption of equivalent amounts of fossil generated feedstock. There are, however, several factors that affect the economic viability of this recycling route.

The liquid oil products derived from plastic waste pyrolysis may not be able to be fed or may require treatment or conditioning before being fed to a liquid steam cracker. High levels of nitrogen, chlorine, and mono and di-olefins, as well as contaminants such as iron and calcium, may require additional consideration or adjustments before being added directly as feed to a steam cracking furnace. To make this feedstock steam cracking ready, this may require hydroprocessing steps as one potential solution, such as first saturating the diolefins followed by mono olefins saturation prior to hydrotreating. However, such steps require a hydrogen supply, addition of multiple high pressure reactors, associated investment (if vessels not available) and operational costs.

Another option to such an approach would be to dilute the negative effects of the nature of the pyrolysis oil, by mixing it with the conventional naphtha feedstock to the cracker. However, the olefins and petrochemical intermediates resulting from the cracking of the pyrolysis oil would be comingled with those from conventional naphtha and would contribute to but a small fraction of the final olefin products, requiring certification as having a particular circular content based on material balance methodology. However, dilution/co-mingling with new hydrocarbon feeds is only a transitional solution, not a viable long-term solution for the circular plastic economy.

Another factor that affects the viability of plastics recycling is that the volume of plastic waste feedstock available through cost effective channels is limited. Due to infrastructure and logistics limitations, the amount of plastic accessible for recycling is limited in each geographical location. Most of the current plastic pyrolysis process technologies available were designed to process no more than 50 T/day of plastic per train. That was not only dictated by limitations on scale-up but also by the waste plastic availability. At this scale, if the pyrolysis oil produced from one of these units, equivalent to a volume of 13,000 Metric Tons per annum, were to be fed to a world scale naphtha cracker, it would comprise only 2 wt % of the total feed to a single steam cracking heater. It is anticipated that waste plastic pyrolysis unit capacities will grow to much larger sizes in the future, in the range of 1,000 to 2,000 tons/day of plastic feed. However, even at these higher capacities, the contribution of the resulting feedstock to a naphtha cracker would be only a fraction of the total feed to a steam cracker. Thus, the resulting products would not be 100% circular, but the resulting products would have a very small percentage of circular components.

The cost of acquiring the plastic waste and the costs associated with sorting and cleaning into a feedstock suitable for pyrolysis are also high. Many proposed processes are inflexible to feed variation and contaminant content, requiring a high amount of sorting and cleaning to produce a useable feedstock. To address the issues with the quality and contamination of the pyrolysis oil feedstock to liquid naphtha crackers, many companies are either using expensive clean and pure recycle plastic feedstock to the pyrolysis unit, such as pure PE, or PP, and either hydroprocessing and hydrotreating it or using dilution effect by blending the pyrolysis oil with much larger volumes of fossil derived naphtha. However, even at higher capacities, such as around 3,800 barrels per day, it may still be uneconomical to hydroprocess and hydrotreat the pyrolysis oil to make the feed suitable for typical steam cracking units.

Yet other factors affecting plastic recycling is that the design throughput capacity of plastics pyrolysis units is typically small, not taking advantage of economy of scale, and the level of product processing needed results in high associated operating and capital costs. The volume and quality of pyrolysis oil product sent, required preparation for further processing, and impact to existing operations makes it difficult to integrate with existing downstream facilities. Further, the revenues from the sale of the pyrolysis products, when commingled with fossil-based products, are often unfavorable compared to the processing costs, and may also fluctuate depending upon the available markets and pricing for the different plastic pyrolysis derived products.

### SUMMARY OF THE CLAIMED EMBODIMENTS

Embodiments herein relate to systems and processes that address one or more of the challenges of converting pyrolysis oil, generated from the thermal pyrolysis of waste materials, such as plastic, back into useful virgin olefins and petrochemical intermediates. In one or more embodiments, the systems and processes may provide for a true circular solution for plastic waste recycling.

In one aspect, embodiments disclosed herein relate to a process for producing raw materials for producing truly circular polymers. The process may include processing a waste-derived hydrocarbon stream, such as a waste plastic pyrolysis oil, in a first reactor system with a catalyst mixture, as well as processing a fossil-based feedstock in a second reactor system with the catalyst mixture. The catalyst mixture may be supplied to each of the first and second reactor systems from a common catalyst regenerator. The processes may also include recovering an effluent comprising fossil-based hydrocarbon products from the second reactor system, and recovering an effluent comprising waste-derived hydrocarbon products from the first reactor system. Following separation of the hydrocarbons from the catalyst in the effluent, the processes may include returning spent catalyst from each of the first and second reactor systems to the common catalyst regenerator.

In various embodiments, the process may include maintaining the fossil-based hydrocarbon products recovered from the first reactor system separate from the waste-derived hydrocarbon products recovered from the second reactor system. Further embodiments may include feeding an olefin fraction recovered from the waste-derived hydrocarbon products to a polymerization system to produce circular polymers. Additionally, the processes may include pyrolyzing a waste stream comprising plastics, tires, or other polymeric materials to produce the waste plastic pyrolysis oil. In yet other embodiments, the processes may include directly or indirectly feeding one or more of the waste-derived hydrocarbon products, or a waste-derived monomer resulting from processing of the waste-derived hydrocarbon products, to a polymerization process to produce a circular polymer.

In another aspect, embodiments herein are directed toward processes for converting waste plastics to feedstock to produce plastics. The processes may include pyrolyzing a waste polymeric feedstock to produce a waste plastic pyrolysis oil. A catalyst mixture may be regenerated in a catalyst regenerator, the catalyst mixture comprising a first catalyst and a second catalyst. A portion of the catalyst mixture may be fed to a first reactor system, and another portion of the catalyst mixture may be fed to a second reactor system. In the first reactor system, a fossil-based feedstock may be contacted with the catalyst mixture to crack a portion of the fossil-based feedstock to produce a first effluent comprising fossil-derived olefins, first catalyst, and second catalyst. In the second reactor system, the waste plastic pyrolysis oil may be contacted with a concentrated catalyst mixture in a reactor to crack a portion of the waste plastic pyrolysis oil, wherein the concentrated catalyst mixture comprises the portion of the catalyst mixture fed to the second reactor system and additional second catalyst, the catalyst mixture in the second reactor system thus having a higher concentration of second catalyst than in the catalyst regenerator or the first reactor system. The contacting in the second reactor system produces a second reactor effluent comprising waste-derived olefins and other hydrocarbons, the first catalyst, and the second catalyst. The second reactor effluent may then be separated to produce a first stream, comprising the first catalyst and the waste-derived olefins and other hydrocarbons, and a second stream, comprising the second catalyst. The second stream may be fed, as the additional second catalyst, to the second reactor, thereby concentrating the second catalyst within the second reactor system. The first effluent may be separated to recover (i) a mixture of spent first catalyst and spent second catalyst and (ii) a first reactor system product stream comprising the fossil-derived olefins. The first stream (effluent and spent first catalyst from the second reactor) may be separated to recover (i) spent first catalyst and (ii) a second reactor system product stream comprising the waste-derived olefins and other waste-derived hydrocarbons. The process may also include feeding to the catalyst regenerator each of (i) the mixture of spent first catalyst and spent second catalyst and (ii) the spent first catalyst.

In some embodiments, the first catalyst comprises one or more selected from the group consisting of amorphous silica alumina, Y-type zeolites, X-type zeolites, zeolite Beta, zeolite MOR, mordenite, faujasite, nano-crystalline zeolites, and MCM mesoporous material.

In various embodiments, the second catalyst comprises one or both of: an additive type cracking catalyst or a mixture of additive type cracking catalysts selected from the group consisting of Medium Pore Zeolites and pentasil family zeolites; or a contaminant trapping additive or a mixture of contaminant trapping additives selected from the group consisting of MgO, CaO, CeO₂, MgTiO₃, CaTiO₃, Li₂Ti₂O₇ and ZnTiO₃, Ca/Mg, boron, a rare earth based trapping additives, or a low chlorine FCC catalyst.

Processes according to some embodiments may also include feeding the first reactor system product stream to a first fractionation system to separate the first reactor system product stream to recover two or more fossil-derived hydrocarbon fractions. The processes according to embodiments herein may further include feeding the second reactor system product stream to a second fractionation system to separate the second reactor system product stream to recover two or more waste-derived hydrocarbon fractions. The processes may also include feeding one or more of the two or more waste-derived hydrocarbon fractions to a polymerization process to produce a circular polymer.

In another aspect, embodiments herein relate to processes for converting waste plastics to feedstock to produce plastics. The processes may include pyrolyzing a waste polymeric feedstock to produce a waste plastic pyrolysis oil having a concentration of one or more contaminants. The contaminants may include, for example, one or more of iron, calcium, copper, potassium, magnesium, sodium, silicon, titanium, zinc and chlorine. The process also includes regenerating a catalyst mixture in a catalyst regenerator, the catalyst mixture comprising a first catalyst and a second catalyst, wherein the second catalyst is configured to trap the one or more contaminants. A portion of the catalyst mixture may be fed to a first reactor system, and another portion of the catalyst mixture may be fed to a second reactor system. In the first reactor system, a fossil-based feedstock may be contacted with the catalyst mixture to crack a portion of the fossil-based feedstock to produce a first effluent comprising fossil-derived olefins, first catalyst, and second catalyst. In the second reactor system: the waste plastic pyrolysis oil may be contacted with a concentrated catalyst mixture in a first stage reactor to remove contaminants from the waste plastic pyrolysis oil and to crack a portion of the waste plastic pyrolysis oil, wherein the concentrated catalyst mixture comprises the portion of the catalyst mixture fed to the second reactor system and additional second catalyst, the catalyst mixture in the first stage reactor thus having a higher concentration of second catalyst than in the catalyst regenerator, and wherein the contacting produces a first stage reactor effluent comprising a treated waste plastic pyrolysis oil having a reduced contaminant concentration, the first catalyst, and the second catalyst containing trapped contaminants. The first stage reactor effluent may be separated to produce a first stream, comprising the first catalyst and the treated waste plastic pyrolysis oil having a reduced contaminant concentration, and a second stream, comprising the second catalyst. The second stream may be fed, as the additional second catalyst, to the first stage reactor, thereby concentrating the second catalyst within the first stage reactor. The first stream may be fed to a second stage reactor to crack the treated waste plastic pyrolysis oil to recover a second stage reactor effluent comprising spent catalyst and waste-derived olefins and other waste-derived hydrocarbons. The first effluent may be separated to recover (i) a mixture of spent first catalyst and spent second catalyst and (ii) a first reactor system product stream comprising the fossil-derived olefins. And, the second stage reactor effluent may be separated to recover (i) spent catalyst and (ii) a second stage reactor system product stream comprising the waste-derived olefins and other waste-derived hydrocarbons. Processes may also include feeding to the catalyst regenerator each of (i) the mixture of spent first catalyst and spent second catalyst and (ii) the spent catalyst.

In some embodiments, the process may further include: feeding the first reactor system product stream to a first fractionation system to separate the first reactor system product stream to recover two or more fossil-derived hydrocarbon fractions; and feeding the second stage reactor system product stream to a second fractionation system to separate the second stage reactor system product stream and to recover two or more waste-derived hydrocarbon fractions.

In various embodiments, the process may further include maintaining the fossil-based hydrocarbon fractions recovered from the first reactor system separate from the waste-derived hydrocarbon products recovered from the second reactor system.

To produce circular polymers, embodiments herein may further include feeding an olefin fraction recovered from the waste-derived hydrocarbon products to a polymerization system to produce circular polymers.

Following separation of the waste-derived hydrocarbon products, processes herein may include feeding one or more hydrocarbon fractions recovered from the waste-derived hydrocarbon products to the first reactor of the second reactor system. In this manner, additional waste-derived olefins may be produced from the waste-based feedstock. In other embodiments, the processes may include feeding one or more hydrocarbon fractions recovered from the waste-derived hydrocarbon products to the second reactor of the second reactor system.

In yet another aspect, embodiments herein relate to processes for converting waste plastic materials into circular polymers. The processes may include pyrolyzing a waste polymeric feedstock to produce a waste plastic pyrolysis oil having a concentration of one or more contaminants selected from the group consisting of iron, calcium, copper, potassium, magnesium, sodium, silicon, titanium, zinc and chlorine. The processes may also include regenerating a catalyst mixture in a catalyst regenerator, the catalyst mixture comprising a first catalyst and a second catalyst, wherein the second catalyst is configured to trap the one or more contaminants. A portion of the catalyst mixture may be fed to a first reactor system, and a portion of the catalyst mixture may be fed to a second reactor system. In the first reactor system, the waste plastic pyrolysis oil may be contacted with a concentrated catalyst mixture in a first reactor to remove contaminants from the waste plastic pyrolysis oil and to crack a portion of the waste plastic pyrolysis oil, wherein the concentrated catalyst mixture comprises the portion of the catalyst mixture fed to the first reactor system and additional second catalyst, the catalyst mixture in the first reactor system thus having a higher concentration of second catalyst than in the catalyst regenerator. The contacting in the first reactor system may produce a first reactor effluent comprising a treated waste plastic pyrolysis oil having a reduced contaminant concentration, the first catalyst, and the second catalyst containing trapped contaminants. The first reactor effluent may then be separated to produce a first stream, comprising the first catalyst and the treated waste plastic pyrolysis oil having a reduced contaminant concentration, and a second stream, comprising the second catalyst. The second stream may be fed, as the additional second catalyst, to the first reactor, thereby concentrating the second catalyst within the first reactor system. The first stream may be fed to a separation system to recover a first separation effluent comprising spent first catalyst and a second separation effluent comprising the treated waste plastic pyrolysis oil. The second separation effluent may be fed to a fractionation system to fractionate the treated waste pyrolysis oil into three or more hydrocarbon fractions, including a light olefin fraction, a naphtha fraction, and a treated pyrolysis oil fraction. At least one of the naphtha fraction and the treated pyrolysis oil fraction may be fed to a second reactor system, contacting the at least one of the naphtha fraction and the heavy oil fraction with the catalyst mixture to crack a portion of the hydrocarbons therein to produce a second reactor system effluent comprising waste-derived olefins, first catalyst, and second catalyst. The second reactor system effluent may then be separated to recover (i) a mixture of spent first catalyst and spent second catalyst and (ii) a second reactor system product stream comprising the waste-derived olefins. The processes may further include feeding to the catalyst regenerator each of (i) the mixture of spent first catalyst and spent second catalyst and (ii) the first separation effluent comprising spent first catalyst.

In yet a further aspect, embodiments herein are directed toward processes for producing raw materials for producing truly circular polymers. The processes may include processing a waste polymer mixture in a first reactor system comprising a first stage reactor and a second stage reactor. The processing of the waste polymer mixture may include feeding the waste polymer mixture to the first stage reactor to pyrolyze polymers therein and to recover a pyrolyzed effluent. The processing of the waste polymer mixture may include feeding a waste-derived plastic pyrolysis oil and a catalyst mixture to the second stage reactor to crack hydrocarbons therein and to recover an effluent comprising cracked hydrocarbons. The pyrolyzed effluent from the first stage reactor and the effluent from the second stage reactor may be fed to a first fractionation system to separate the effluents into two or more waste-derived hydrocarbon streams including the waste-derived plastic pyrolysis oil and one or more waste-derived olefin fractions. A fossil-based feedstock may be processed in a second reactor system with the catalyst mixture. Further, the processes may include supplying the catalyst mixture to each of the first and second reactor systems from a common catalyst regenerator. An effluent comprising fossil-based hydrocarbon products may be recovered from the second reactor system, and the effluent comprising fossil-based hydrocarbon products may be fed to a second fractionation system. The processes may also include returning spent catalyst from each of the first and second reactor systems to the common catalyst regenerator.

In some embodiments of the processes, the catalyst mixture comprises a first catalyst and a second catalyst, and wherein the second stage reactor is a catalyst-concentrating reactor system. The processes may include recovering a second stage reactor effluent comprising the catalyst mixture and the cracked hydrocarbons. The second stage reactor effluent may be separated to produce a first stream, comprising the first catalyst and the cracked hydrocarbons, and a second stream, comprising the second catalyst. The first stream may be separated to recover a (i) spent catalyst and (ii) the second stage reactor effluent fed to the first fractionation system. The processes may also include feeding the second stream to the second stage reactor, thereby concentrating the second catalyst circulating within the second reactor to a concentration greater than the catalyst mixture as received from the regenerator.

In any of the above-described processes, the waste polymeric pyrolysis oil may be derived from, or the waste polymeric feed or waste polymer mixture may include, one or more thermoplastics selected from the group consisting of polystyrene, polypropylene, polyphenylene sulfide, polyphenylene oxide, polyethylene, polyetherimide, polyether ether ketone, polyoxymethylene, polyether sulfone, polycarbonate, polybenzimidazole, polylactic acid, nylon, acrylonitrile-butadiene-styrene (ABS) polymers, poly methyl methacrylic acid (PMMA); one or more thermosets formed from monomers including one or more of acrylics, polyesters, vinyl esters, epoxies, urethanes, ureas, and isocyanates; and one or more unsaturated or saturated elastomers selected from the group consisting of polybutadiene, isoprene, chloroprene, styrene-butadiene, nitrile, and ethylene vinyl acetate.

In another aspect, embodiments disclosed herein relate to apparatuses and process schemes that produces re-circular virgin light olefins and petrochemical intermediates. In another aspect, embodiments disclosed herein relate to processes and apparatuses that treat the pyrolysis oil contaminants and yet produces re-circular virgin light olefins and petrochemical intermediates. In yet another aspect, embodiments herein are directed toward systems for performing the processes as outlined above.

In some aspects, embodiments herein are directed toward systems for producing raw materials for producing truly circular polymers. The systems may include a first reactor system containing a catalyst mixture and configured for processing a waste plastic pyrolysis oil, as well as a second reactor system configured for processing a fossil-based feedstock with the catalyst mixture. Feed lines may be configured for supplying the catalyst mixture to each of the first and second reactor systems from a common catalyst regenerator. A flow line may be configured for recovering an effluent comprising fossil-based hydrocarbon products from the second reactor system. Another flow line may be configured for recovering an effluent comprising waste-derived hydrocarbon products from the first reactor system. Further flow lines may be configured for returning spent catalyst from each of the first and second reactor systems to the common catalyst regenerator. In some embodiments, the systems further include a waste plastic pyrolysis system configured to pyrolyze a waste stream comprising plastics, tires, or other polymeric materials to produce the waste plastic pyrolysis oil.

In other aspects, embodiments herein are directed toward systems for converting waste plastics to feedstock to produce circular plastics. The systems include a waste plastic pyrolysis reactor system configured for pyrolyzing a waste polymeric feedstock to produce a waste plastic pyrolysis oil. A catalyst regenerator is provided for regenerating a catalyst mixture, the catalyst mixture including a first catalyst and a second catalyst. A first flow line is provided for feeding a portion of the catalyst mixture from the catalyst regenerator to a first reactor system. Similarly, a second flow line is provided for feeding a portion of the catalyst mixture from the catalyst regenerator to a second reactor system. The first reactor system is configured for contacting a fossil-based feedstock with the catalyst mixture to crack a portion of the fossil-based feedstock to produce a first effluent comprising fossil-derived olefins, first catalyst, and second catalyst. The second reactor system is configured for: contacting the waste plastic pyrolysis oil with a concentrated catalyst mixture in a reactor to crack a portion of the waste plastic pyrolysis oil, wherein the concentrated catalyst mixture comprises the portion of the catalyst mixture fed to the second reactor system and additional second catalyst, the catalyst mixture in the second reactor system thus having a higher concentration of second catalyst than in the catalyst regenerator or the first reactor, and wherein the contacting produces a second reactor effluent comprising waste-derived olefins and other hydrocarbons, the first catalyst, and the second catalyst; separating the second reactor effluent to produce a first stream, comprising the first catalyst and the waste-derived olefins and other hydrocarbons, and a second stream, comprising the second catalyst; and feeding the second stream, as the additional second catalyst, to the second reactor, thereby concentrating the second catalyst within the second reactor system. The system further includes a first separation system for separating the first effluent to recover (i) a mixture of spent first catalyst and spent second catalyst and (ii) a first reactor system product stream comprising the fossil-derived olefins. Another separation system is provided for separating the first stream to recover (i) spent first catalyst and (ii) a second reactor system product stream comprising the waste-derived olefins and other hydrocarbons. Flow lines are also provided for feeding to the catalyst regenerator each of (i) the mixture of spent first catalyst and spent second catalyst and (ii) the spent first catalyst. In some embodiments, the systems include a first fractionation system and a second fractionation system. The first separation system is configured to separate the first reactor system product stream to recover two or more fossil-derived hydrocarbon fractions. The second fractionation system is configured to separate the second reactor system product stream to recover two or more waste-derived hydrocarbon fractions. Other embodiments of the system may include a polymerization system configured to directly or indirectly receive one or more of the two or more waste-derived hydrocarbon fractions, or a monomer resulting from processing of one or more of the two or more waste-derived hydrocarbon fractions, to produce a circular polymer.

In some aspects, embodiments herein are directed toward systems for converting waste plastics to feedstock to produce plastics. The systems may include a pyrolysis reactor system for pyrolyzing a waste polymeric feedstock to produce a waste plastic pyrolysis oil having a concentration of one or more contaminants selected from the group consisting of iron, calcium, copper, potassium, magnesium, sodium, silicon, titanium, zinc and chlorine. A catalyst regenerator regenerates a catalyst mixture, the catalyst mixture comprising a first catalyst and a second catalyst, wherein the second catalyst is configured to trap the one or more contaminants. A flow line feeds a portion of the catalyst mixture from the catalyst regenerator to a first reactor system. Another flow line feeds a portion of the catalyst mixture from the catalyst regenerator to a second reactor system. The first reactor system is configured for contacting a fossil-based feedstock with the catalyst mixture to crack a portion of the fossil-based feedstock to produce a first effluent comprising fossil-derived olefins, first catalyst, and second catalyst. The second reactor system is configured for: contacting the waste plastic pyrolysis oil with a concentrated catalyst mixture in a first stage reactor to remove contaminants from the waste plastic pyrolysis oil and to crack a portion of the waste plastic pyrolysis oil. The concentrated catalyst mixture comprises the portion of the catalyst mixture fed to the second reactor system and additional second catalyst. The catalyst mixture in the first stage reactor thus has a higher concentration of second catalyst than in the catalyst regenerator. Further, the contacting produces a first stage reactor effluent comprising a treated waste plastic pyrolysis oil having a reduced contaminant concentration, the first catalyst, and the second catalyst containing trapped contaminants. The first reactor system may include a separator for separating the first stage reactor effluent to produce a first stream, comprising the first catalyst and the treated waste plastic pyrolysis oil having a reduced contaminant concentration, and a second stream, comprising the second catalyst. A flow line may be provided for feeding the second stream, as the additional second catalyst, to the first stage reactor, thereby concentrating the second catalyst within the first stage reactor. The reactor system may further include a flow line for feeding the first stream to a second stage reactor to crack the treated waste plastic pyrolysis oil to recover a second stage reactor effluent comprising spent catalyst and waste-derived olefins and other waste-derived hydrocarbons. A first separation system is configured for separating the first effluent to recover (i) a mixture of spent first catalyst and spent second catalyst and (ii) a first reactor system product stream comprising the fossil-derived olefins. A second separation system is configured for separating the second stage reactor effluent to recover (i) spent catalyst and (ii) a second stage reactor system product stream comprising the waste-derived olefins and other waste-derived hydrocarbons, and flow lines are provided for feeding to the catalyst regenerator each of (i) the mixture of spent first catalyst and spent second catalyst and (ii) the spent catalyst. In some embodiments, the system further includes a first fractionation system and a second fractionation system. The first fractionation system is configured to separate the first reactor system product stream to recover two or more fossil-derived hydrocarbon fractions. The second fractionation system is configured to separate the second stage reactor system product stream and to recover two or more waste-derived hydrocarbon fractions. In some embodiments, the system may be configured for maintaining the fossil-based hydrocarbon fractions recovered from the first reactor system separate from the waste-derived hydrocarbon products recovered from the second reactor system. Various embodiments also include a polymerization configured to directly or indirectly receive a monomer recovered or derived from the waste-derived hydrocarbon products to produce circular polymers. Some embodiments of the system include a flow line for feeding one or more hydrocarbon fractions recovered from the waste-derived hydrocarbon products to the first reactor of the second reactor system, while others include a flow line for feeding one or more hydrocarbon fractions recovered from the waste-derived hydrocarbon products to the second reactor of the second reactor system. A flow line may also be provided for withdrawing a portion of the second catalyst from the first reactor.

In other aspects, embodiments herein are directed toward systems for converting waste plastic materials into circular polymers. The systems may include a waste plastic pyrolysis reactor for pyrolyzing a waste polymeric feedstock to produce a waste plastic pyrolysis oil having a concentration of one or more contaminants selected from the group consisting of iron, calcium, copper, potassium, magnesium, sodium, silicon, titanium, zinc and chlorine. A catalyst regenerator is provided for regenerating a catalyst mixture, the catalyst mixture comprising a first catalyst and a second catalyst, wherein the second catalyst is configured to trap the one or more contaminants. The system includes a flow line for feeding a portion of the catalyst mixture to a first reactor system as well as a flow line for feeding a portion of the catalyst mixture to a second reactor system. The first reactor system is configured for: contacting the waste plastic pyrolysis oil with a concentrated catalyst mixture in a first reactor to remove contaminants from the waste plastic pyrolysis oil and to crack a portion of the waste plastic pyrolysis oil, wherein the concentrated catalyst mixture comprises the portion of the catalyst mixture fed to the first reactor system and additional second catalyst, the catalyst mixture in the first reactor system thus having a higher concentration of second catalyst than in the catalyst regenerator, and wherein the contacting produces a first reactor effluent comprising a treated waste plastic pyrolysis oil having a reduced contaminant concentration, the first catalyst, and the second catalyst containing trapped contaminants; separating the first reactor effluent to produce a first stream, comprising the first catalyst and the treated waste plastic pyrolysis oil having a reduced contaminant concentration, and a second stream, comprising the second catalyst; feeding the second stream, as the additional second catalyst, to the first reactor, thereby concentrating the second catalyst within the first reactor system; and a separation system to recover a first separation effluent comprising spent first catalyst and a second separation effluent comprising the treated waste plastic pyrolysis oil. A fractionation system is used to fractionate the treated waste pyrolysis oil into three or more hydrocarbon fractions, including a light olefin fraction, a naphtha fraction, and a treated pyrolysis oil fraction. The system includes a flow line for feeding at least one of the naphtha fraction and the treated pyrolysis oil fraction to a second reactor system. The second reactor system is configured for contacting the at least one of the naphtha fraction and the heavy oil fraction with the catalyst mixture to crack a portion of the hydrocarbons therein to produce a second reactor system effluent comprising waste-derived olefins, first catalyst, and second catalyst. A separation system is provided, the separation system being configured for separating the second reactor system effluent to recover (i) a mixture of spent first catalyst and spent second catalyst and (ii) a second reactor system product stream comprising the waste-derived olefins. The system further includes flow lines for feeding to the catalyst regenerator each of (i) the mixture of spent first catalyst and spent second catalyst and (ii) the first separation effluent comprising spent first catalyst.

In yet other aspects, embodiments herein are directed toward systems for producing raw materials for producing truly circular polymers. The system may include a first reactor system comprising a first stage reactor and a second stage reactor. A waste polymer mixture is fed to the first stage reactor to pyrolyze polymers therein and to recover a pyrolyzed effluent. A waste-derived plastic pyrolysis oil and a catalyst mixture are fed to the second stage reactor to crack hydrocarbons therein and to recover an effluent comprising cracked hydrocarbons. The pyrolyzed effluent from the first stage reactor and the effluent from the second stage reactor are fed via flow lines to a first fractionation system to separate the effluents into two or more waste-derived hydrocarbon streams including the waste-derived plastic pyrolysis oil and one or more waste-derived olefin fractions. The system further includes a second reactor system configured for processing a fossil-based feedstock with the catalyst mixture. A common catalyst regenerator is provided and configured for supplying the catalyst mixture to each of the first and second reactor systems. A flow line is configured for recovering an effluent comprising fossil-based hydrocarbon products from the second reactor system. A second fractionation system is provided and configured for separating the effluent comprising fossil-based hydrocarbon products. The system further includes flow lines for returning spent catalyst from each of the first and second reactor systems to the common catalyst regenerator. In some embodiments, the catalyst mixture comprises a first catalyst and a second catalyst, and wherein the second stage reactor is a catalyst-concentrating reactor system.

Other aspects and advantages will be apparent from the following description and the appended claims.

### BRIEF DESCRIPTION OF DRAWINGS

FIGS. 1, 1A, 2 and 3 illustrate simplified process flow diagrams of systems and processes according to one or more embodiments disclosed herein.

### DETAILED DESCRIPTION

Embodiments herein are directed generally to processing of waste materials to form virgin feedstocks, such as light olefins and petrochemical intermediates. Waste materials, such as plastics, elastomers, and other polymeric materials, for example, may undergo pyrolysis to break down the polymeric materials and to form a pyrolysis oil. Processes and systems herein may advantageously process such a waste-derived pyrolysis oil to form olefins and petrochemical intermediates. Such olefins and petrochemical intermediates may then be used to again form polymeric materials, including thermoplastics and elastomeric polymers, providing, in some embodiments, truly circular polymers.

As used herein, circular polymers, circular plastics, circular elastomers, and other similar “circular” or “re-circular” terms refers to the cyclic process of producing a polymer from a monomeric component, such as ethylene or propylene, producing and using a consumer product formed with the polymer to result in a waste (used) polymeric material, and then conversion of that waste polymeric material back into the monomeric component to again be transformed into a polymer for conversion into a consumer product. Embodiments herein are, in large part, directed toward the conversion of the waste polymeric materials back into the monomeric component.

Embodiments herein for conversion of the waste materials may include stand-alone systems specifically directed toward processes for producing raw materials that may be used for producing truly circular polymers. Other embodiments herein for the conversion of the waste materials may include systems integrated with processes for converting fossil-based materials into olefins, fuels, and other products typically produced in a refinery. In some embodiments, a system for converting fossil-based materials may be retrofitted to additionally process waste-based materials as described herein.

Beginning with the integrated systems and processes, embodiments herein may include a first reaction system for catalytically converting the waste-based materials, a second reaction system for catalytically converting the fossil-based materials, and a common catalyst regeneration system for regenerating the catalyst mixtures used in each of the first and second reaction systems. A waste-derived hydrocarbon stream, such as a waste plastic pyrolysis oil, may be fed to a first reactor system and contacted with a catalyst mixture, to crack hydrocarbons therein into lighter waste-derived hydrocarbons. A fossil-based feedstock, such as a gas oil fraction or other various hydrocarbon cuts directly or indirectly derived from a crude oil, may be fed to a second reactor system and contacted with the catalyst mixture, to crack hydrocarbons therein into lighter fossil-derived hydrocarbons. The catalyst mixture supplied to each of the first and second reactor systems may be provided from a common catalyst regenerator. An effluent comprising fossil-based hydrocarbon products and spent catalyst may be recovered from the second reactor system. Likewise, an effluent comprising waste-derived hydrocarbon products and spent catalyst may be recovered from the first reactor system. Following separation of the respective effluents, spent catalyst from each of the first and second reactor systems may be returned to the common catalyst regenerator for regeneration and reuse in the reactors.

In some embodiments, the reactor effluents may be fed to a common fractionation system for processing of the hydrocarbon products. However, such embodiments may result in commingling of the waste-derived hydrocarbons and the fossil-derived hydrocarbons.

In other embodiments, the fossil-based hydrocarbon products recovered from the first reactor system may be maintained and processed separate from the waste-derived hydrocarbon products recovered from the second reactor system. In this manner, the waste-derived hydrocarbon products may be provided as purely cyclical and the consumer products therefrom as truly re-circular products. For example, an olefin fraction recovered from the waste-derived hydrocarbon products may be fed to a polymerization system to produce circular polymers.

Waste-derived hydrocarbon streams useful in embodiments herein may be derived from any number of sources. In some embodiments, for example, the waste-derived hydrocarbon stream may be formed by pyrolyzing a waste stream comprising polymeric materials, such as thermoplastics, tires, or other polymeric materials, producing a waste plastic pyrolysis oil.

Polymers that may by pyrolyzed to form a waste plastic pyrolysis oil may include thermoplastics, thermosets, and elastomers. For example, waste material undergoing pyrolysis to form a waste plastic pyrolysis oil may include polystyrene, polypropylene, polyphenylene sulfide, polyphenylene oxide, polyethylene, polyetherimide, polyether ether ketone, polyoxymethylene, polyether sulfone, polycarbonate, polybenzimidazole, polylactic acid, nylon, and acrylic polymers such as poly methyl methacrylic acid (PMMA), among many other thermoplastics. Waste plastic pyrolysis oils useful herein may also be formed from various unsaturated or saturated elastomers and rubbers known in the art, such as polybutadiene, isoprene, styrene-butadiene, ethylene vinyl acetate, and many, many others. Embodiments herein may be robust enough to process some quantity of heteroatom-containing polymers, including those listed above as well as others known in the art; however, a heteroatom content of the resulting waste plastic pyrolysis oil should typically be less than 2 wt %, such as less than 1 wt % or less than 0.5 wt %.

Pyrolysis of the above-described polymeric waste materials may be performed by thermally or catalytically pyrolyzing a polymeric waste material. For example, thermal pyrolysis of a plastic feedstock may be conducted by contacting a plastic feedstock at an elevated temperature, such as a temperature in the range from 300° C. to 850° C., such as from about 350° C. to about 600° C. Pyrolysis of the plastics may produce various hydrocarbons, including light gas hydrocarbon products and liquid hydrocarbon products, the total or a portion of which may be used as the waste plastic pyrolysis oil herein.

Polymeric materials are commonly processed to produce end products, where the polymerization catalysts and various additives such as metallic colorants and cross-linking agents, which introduce various contaminants into the pyrolysis process, such as iron, calcium, and sulfur, among others, are retained in the polymers produced. The polymers themselves may also contain various atoms, such as oxygen, nitrogen, chlorine, and fluorine, that may be considered as a contaminant in a typical cracking process. Embodiments herein may pre-process the waste plastic pyrolysis liquids to remove some of, or a majority of, these contaminants. In other embodiments, processes herein may be robust enough to advantageously convert waste plastic pyrolysis liquids without such costly pre-processing.

Turning waste materials into the olefins and petrochemicals, then into finished consumer products, and then again using the resulting discarded and waste products as raw materials to convert into the valuable light olefins and petrochemicals may provide for a truly re-circular product generation. Embodiments herein also contemplate “green” products, where feedstocks to the waste reactor may also include bio-derived oils, biomass, bio-waste materials, and other renewable feedstocks that may be cracked to produce olefins such as propylene and ethylene, among others, and/or to produce other petrochemical intermediates. Use of such materials may provide feedstock flexibility while also being able to classify the olefins and other petrochemicals produced, and consumer products made therefrom, as not being fossil derived products.

The integrated processes herein, as noted above, may use a common catalyst regenerator to process the individual waste-derived and fossil-derived feeds. Fossil-derived feeds that may be processed according to embodiments herein may include crude oils or any number of hydrocarbon fractions directly or indirectly produced therefrom. For example, embodiments herein may crack fossil-derived hydrocarbons including one or more light hydrocarbon fractions, such as those having a boiling point no greater than about 200° C. or 250° C. or any portion thereof, such as a naphtha fraction, and/or one or more heavy hydrocarbon fractions, such as those with boiling points in the range from about 200° C. or 250° C. up to about 600° C. or 700° C., or any portion thereof, such as an atmospheric gas oil, a vacuum gas oil, diesel, and atmospheric or vacuum residues, among others.

Catalysts useful in embodiments herein may include various fluid catalytic cracking (FCC) catalysts. Suitable FCC catalysts may include Y-type zeolites, X-type zeolites, mordenite, faujasite, nano-crystalline zeolites, and MCM mesoporous materials, among others known in the art. Typically, such catalysts are selective for cracking heavier hydrocarbons.

Additive type cracking catalysts may include various medium pore zeolites, such as the pentasil family of zeolites (ZSM-5 or ZSM-11, for example). Typically, such catalysts are selective for cracking lighter hydrocarbons, such as C4 and naphtha range hydrocarbons, for the production of light olefins, such as ethylene, propylene, and butenes.

Embodiments herein may also use contaminant trapping additives (trapping catalysts, passivators, etc.). Useful contaminant trapping additives are compounds and structures that have a higher affinity for the contaminants than the FCC or additive type cracking catalyst at reaction conditions. The contaminant may thus be preferentially absorbed or retained on the contaminant trapping additive. Contaminant trapping additives may include MgO, CaO, CeO2, MgTiO3, CaTiO3, Li2Ti2O7 and ZnTiO3, Ca/Mg, boron, and other rare earth based trapping additives. Useful contaminant trapping additives may also include low chlorine FCC catalysts, among others.

As noted above, various contaminants may be encountered with the waste plastic pyrolysis oils used. Contaminants that may be encountered with various waste plastic pyrolysis oil feedstocks may include one or more of iron, copper, calcium, phosphorous, vanadium, nickel, sodium, and chlorine, among others. Such contaminants can have a detrimental effect on the performance of catalysts, such as cracking catalysts, including FCC catalysts, used for converting heavier hydrocarbons to lighter hydrocarbons. Various contaminants may poison the cracking catalyst and reduce its activity and/or require increased daily fresh catalyst make up rates to the processes. The contaminants may also plug pores or reduce diffusivity through the catalyst pores, inhibiting the effectiveness of the catalyst.

The contaminant trapping additive, as noted above, should have a higher affinity for the contaminant than the catalyst. The particular type of contaminant trapping additive used may thus depend on the particular contaminant(s) to be targeted. Contaminant trapping additives useful in some embodiments disclosed herein may include commercially available vanadium/nickel/iron traps (additives) manufactured by FCC catalyst vendors.

Embodiments herein may utilize a mixture of FCC catalyst and additive type cracking catalysts. Other embodiments herein may utilize a mixture of FCC catalyst and metal/contaminants trapping catalysts. Yet other embodiments may utilize a mixture of FCC catalysts, additive type cracking catalysts, and trapping catalysts.

Although circulated from the catalyst regenerator as a homogeneous mixture of the various catalysts employed, embodiments herein may desirably concentrate one or more of the catalysts in a reactor. For example, it may be desirable to increase a concentration of the additive type cracking catalyst or the trapping catalyst within a reactor vessel, such that the reactions occurring within that vessel are enhanced with respect to the concentrated catalyst, taking advantage of the concentrated catalyst to improve reactor dynamics.

Embodiments herein may advantageously concentrate a catalyst within a reactor by taking advantage of a size and/or density difference between the catalyst types. For example, a first catalyst, such as the Y-type based zeolite, may have a particle size in the range of 20-200 microns and an apparent bulk density in the range of 0.60-1.0 g/ml. A second catalyst, such as ZSM-5 or ZSM-11, may have a particle size in the range of 20-350 microns and an apparent bulk density in the range of 0.7-1.2 g/ml. Such catalysts may be separated based on one or both of size and density, and the heavier or more dense catalyst may be advantageously recycled to a reactor to concentrate the catalyst within the reactor. Such catalyst separations and concentration within a reactor may be performed, in some embodiments, using the processes and systems as described in U.S. Pat. Nos. 10,450,514, 10,758,883, 10,351,786, or 9,452,404, for example, each of which are incorporated herein by reference to the extent not contradictory to embodiments herein.

Each of the waste-based feedstock reactor system and the fossil-based feedstock reactor system may receive the same mixture of catalyst from the regenerator. For example, the catalyst mixture may include FCC catalyst and ZSM-5 catalyst, respectively, at a ratio of 9:1 to 4:1 (weight, volume, particle count, or otherwise). Concentration of the larger, more dense ZSM-5 catalyst within the waste-based feedstock reactor system according to embodiments herein may provide for the catalyst mixture circulating within the waste-based feedstock reactor system to be at a FCC to ZSM-5 ratio of 0.2:1 to 9.5:1, such as 1:4. These ratios are only exemplary, as the ratio of catalysts within the regenerator may vary, depending upon the fossil-based feedstock being processed, the fossil-based feedstock reactor system configuration, respective fresh catalyst feed rates and spent catalyst withdrawal rates, as well as the fluidization conditions and catalyst separations/recycle variables (separation efficiency, recycle rates, fresh catalyst make up feed rates, spent catalyst withdrawal rates, etc.) associated with the waste-based feedstock reactor system, among other variables.

In particular embodiments, a catalyst mixture contained in and circulating from a regenerator may have a first catalyst to second catalyst weight ratio in the range from 2:1 to 9:1, where the first catalyst is lighter and/or less dense than the second catalyst. A riser reactor for converting a fossil-based hydrocarbon feedstock may thus operate at a first catalyst to second catalyst ratio similar to that contained in the regenerator. A reactor for converting a waste-based hydrocarbon feedstock, while receiving catalyst at a ratio similar to that contained in the regenerator, may operate with a circulating first catalyst to second catalyst ratio lower than that in the regenerator, such as at a ratio in the range from 1:1 to 1:9.

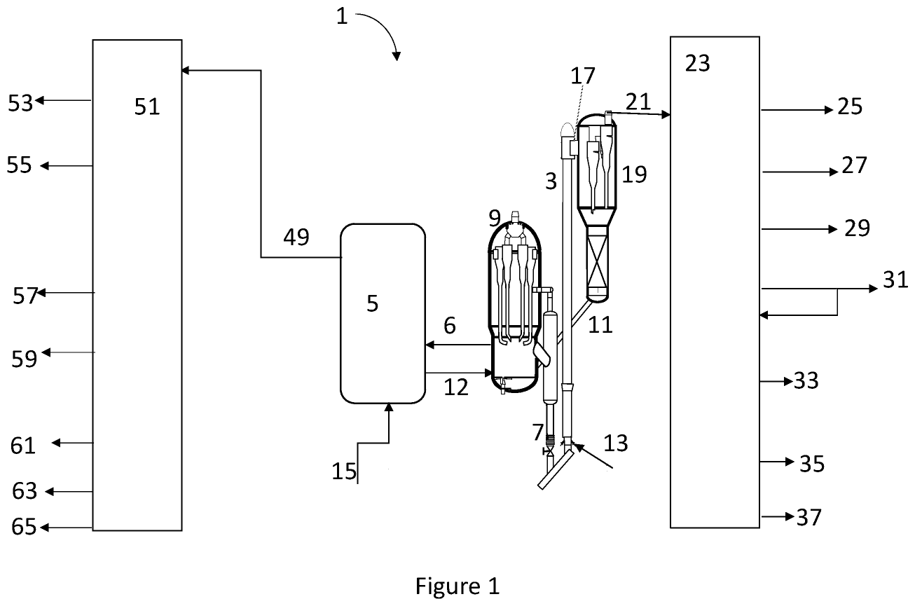

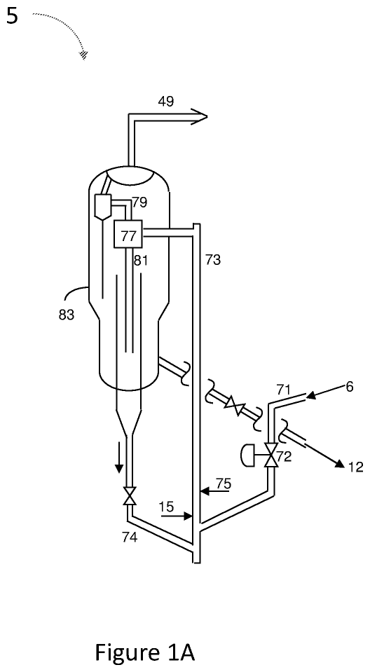

Referring now to FIG. 1, a simplified process flow diagram of a system 1 for converting waste plastics to feedstock for producing plastics is illustrated. System 1 may include a first reactor system 3 and a second reactor system 5, each receiving regenerated catalyst 6, 7 from a catalyst regenerator 9 and each returning spent catalyst 11, 12 to the catalyst regenerator 9. The catalyst mixture being recirculated between the regenerator 9 and the reactor systems 3, 5 may be a homogeneous mixture of a first catalyst and a second catalyst, such as a mixture of an FCC catalyst and an additive catalyst, for example as a mixture of Y-Zeolite and ZSM-5. Regenerator 9, for example, may operate at a temperature in the range from about 600° C. to about 750° C. and a pressure in the range from about 1 barg to about 5 barg.

A fossil-derived hydrocarbon feed stream 13 may be fed to first reactor system 3. The fossil-derived hydrocarbon feed may be, as noted above, one or more hydrocarbon fractions, such as a naphtha fraction, a gas oil fraction, or other hydrocarbon fractions derived from crude oil, for example.

A waste-derived hydrocarbon feed stream 15 may be fed to the second reactor system 5 for conversion (cracking) into lighter hydrocarbons. The system may also include a pyrolysis reactor (not illustrated) for pyrolyzing a waste stream, such as a waste polymeric feedstock, to produce the waste-derived hydrocarbon feed stream 15, such as a waste plastic pyrolysis oil. For example, a catalytic or non-catalytic plastics pyrolysis unit (not illustrated) may be used to pyrolyze a polymeric waste, producing a waste plastic pyrolysis oil stream 15, among other products (not illustrated). Alternatively, a waste plastic pyrolysis oil feedstock 15 may be supplied from a remote source (not illustrated), and may be fed into the conversion unit of FIG. 1 via truck or pipeline, for example.

In the first reactor system 3, the fossil-based hydrocarbon feedstock 13 may be contacted with the catalyst mixture to crack a portion of the fossil-based feedstock. The heat required for vaporization of the fossil-based feedstock and/or raising the temperature of the feed to the desired reactor temperature, such as in the range from 500° C. to about 750° C., and for the endothermic heat (heat of reaction) may be provided by the hot regenerated catalyst coming from the regenerator 9. The pressure in first reactor system 3, which may include a riser reactor, is typically in the range from about 1 barg to about 5 barg. As the heat of reaction decreases the temperature along a length of the reactor, the reactor may start at a temperature of, for example, 600° C. to 750° C., which may be favorable for cracking C4, C5, and naphtha range hydrocarbons, decreasing to lower reactor temperatures, such as 475° C. to 520° C., which may be favorable for cracking heavier hydrocarbon feedstocks. Accordingly, the various feeds to the reactor may be introduced along the length of the reactor where conditions are favorable for their processing.

An effluent 17 may be recovered from reactor system 3, the effluent including fossil-derived olefins (cracked hydrocarbon product), first catalyst, and second catalyst. Effluent 17 may then be quenched, if desired, and forwarded to a separation system 19 for separating the first effluent to recover (i) a mixture 11 of spent first catalyst and spent second catalyst and (ii) a first reactor system product stream 21 comprising the fossil-derived olefins and other fossil-derived hydrocarbon products resulting from the processing of the fossil-based hydrocarbon feedstock 13. The mixture 11 of spent catalyst may then be returned to the catalyst regenerator 9 for regeneration and reuse in the reactors. When a quench is used, a hydrocarbon feed such as heavy vacuum gas oil, atmospheric tower bottoms, heavy hydrocarbon residue feed, light cycle oil (LCO), and/or steam may be injected as a quench media.

Following separation of the spent catalyst 11 from the fossil-derived hydrocarbon products 21, the fossil-derived hydrocarbon products may be forwarded to a fractionation system 23, where the fossil-derived hydrocarbons may be fractionated into any number of discrete fossil-derived hydrocarbon fractions based on boiling point. As illustrated, the fossil-derived hydrocarbon product stream 21 may be fractionated in fractionation system 23 to recover an ethylene-containing fraction 25, a propylene-containing fraction 27, a butene-containing fraction 29, a C5 fraction 31, a naphtha fraction 33, a light cycle oil fraction 35, and a slurry oil fraction 37. Each of these fractions may be further processed or recovered for sale as a product fraction. For example, the naphtha fraction may be processed to recover aromatics, used in the gasoline pool, and/or may be recycled to reactor system 3 for conversion of the naphtha range hydrocarbons into additional ethylene and propylene. As another example, the C5 fraction may be used for the gasoline pool, and/or may be fed to an olefins conversion unit (not illustrated) or recycled back to reactor system 3 to convert the C5s therein into additional ethylene and propylene.

In the second reactor system 5 the waste-derived hydrocarbon stream 15, such as a waste plastic pyrolysis oil, may be contacted with a concentrated catalyst mixture formed from the regenerated catalyst mixture 6 provided from regenerator 9. Contact with the concentrated catalyst mixture in reactor system 5 may crack a portion of the waste-derived hydrocarbons to produce a second reactor system effluent including waste-derived olefins and other waste-derived hydrocarbons, the first catalyst and the second catalyst. The heat required for vaporization of the waste-based feedstock and/or raising the temperature of the feed to the desired reactor temperature, such as in the range from 500° C. to about 750° C., and for the endothermic heat (heat of reaction) may be provided by the hot regenerated catalyst coming from the regenerator 9. The pressure in second reactor system 5, which may include a riser reactor, for example, is typically in the range from about 1 barg to about 5 barg. As the heat of reaction decreases the temperature along a length of the reactor, the reactor may start at a temperature of, for example, 600° C. to 750° C., which may be favorable for cracking C4, C5, and naphtha range hydrocarbons, decreasing to lower reactor temperatures, such as 475° C. to 520° C., which may be favorable for cracking heavier hydrocarbon feedstocks. Accordingly, the various waste-based feeds to the reactor may be introduced along the length of the reactor where conditions are favorable for their processing.

The concentrated catalyst mixture in the second reactor system includes the portion of the catalyst mixture fed to the second reactor system from the regenerator and additional second catalyst, the catalyst mixture in the second reactor system thus having a higher concentration of second catalyst than in the catalyst regenerator or the first reactor. Following conversion in the second reactor system and recovery of the effluent, the second reactor effluent may be optionally quenched, if desired, and then separated to produce a first stream, comprising the first catalyst and the waste-derived olefins and other hydrocarbons, and a second stream, comprising the second catalyst. The second stream may then be returned to the second reactor system, as the additional second catalyst, thereby concentrating the second catalyst within the second reactor system.

The first stream, depleted in second catalyst, may be quenched, if desired, and fed to a catalyst separator to recover (i) a spent first catalyst fraction 12 and (ii) a second reactor system product stream 49, including the waste-derived olefins and other waste-derived hydrocarbons. The spent catalyst 12 may then be returned to the catalyst regenerator 9 for regeneration and reuse in the reactors. When a quench is used, a waste-based hydrocarbon feed such as heavy vacuum gas oil, atmospheric tower bottoms, heavy hydrocarbon residue feed, light cycle oil (LCO), and/or steam may be injected as a quench media, such as where the waste-based hydrocarbon quench is provided by a fractionation system 51.

Following separation of the spent catalyst 12 from the waste-derived hydrocarbon products 49, the waste-derived hydrocarbon products may be forwarded to a fractionation system 51, where the waste-derived hydrocarbons may be fractionated into any number of discrete waste-derived hydrocarbon fractions based on boiling point. As illustrated, the waste-derived hydrocarbon product stream 49 may be fractionated in fractionation system 51 to recover an ethylene-containing fraction 53, a propylene-containing fraction 55, a butene-containing fraction 57, a C5 fraction 59, a naphtha fraction 61, a light cycle oil fraction 63, and a treated pyrolysis oil fraction 65. Each of these fractions may be further processed or recovered for sale as a waste-derived product fraction. For example, the ethylene and propylene streams, among other hydrocarbon fractions that may be recovered, may be further purified, if necessary, to provide a polymer grade waste-derived olefin fraction, having, for example, greater than 99.8% purity. Such waste-derived olefin fractions may then be provided to a polymerization unit for production of a circular polymer. As another example, the butene-containing fraction 57, or a C4-containing fraction, may be further separated and/or processed to produce a waste-derived propylene and ethylene which may then be provided to a polymerization unit for production of a circular polymer. As yet another example, the naphtha fraction 61 may be further purified and/or processed to recover a circular aromatics fraction. The waste-derived aromatics may then be provided for production of aromatic-containing circular polymers, such as polystyrene, styrene-butadiene rubber (SBR), and many other types of aromatic-containing polymers known in the art. Various product fractions or portions thereof may also be further processed to provide feedstocks suitable for production of polyethers, polyesters, and other circular polymers.

As can be readily envisioned, any of a large number and type of circular polymers can be made from the waste-derived fractions resulting from the pyrolysis and processing of waste-plastics according to embodiments herein. In general, embodiments herein may include directly or indirectly feeding one or more monomers recovered or derived from the waste-derived hydrocarbon product fractions to a polymerization system to produce circular polymers. Embodiments herein contemplate production of circular polymers including the polymers that may by pyrolyzed to form a waste plastic pyrolysis oil noted above, among other possible circular polymers.

In some embodiments, second reactor system 5 may be similar to that as illustrated in FIG. 1A. Regenerated mixed first and second catalysts 6 may be fed from common catalyst regenerator 9 via flow line 71 through control valve 72 to the bottom of a riser reactor 73. At the bottom of riser reactor 73, the regenerated mixed catalyst mixes with additional second catalyst fed via flow line 74. The catalyst in flow line 74 may have a higher concentration of larger and/or heavier second catalyst, such as ZSM-5.

The mixed catalyst in riser reactor 73, having a higher concentration of larger and/or heavier second catalyst than as supplied in the mixture 6 from the regenerator 9, may then be contacted with hydrocarbons in secondary riser reactor 73. For example, a waste plastic pyrolysis oil feed 5 may be introduced to a lower portion of the riser reactor 73 and lifting steam, if used, may be fed to riser reactor 73 via flow line 75. The waste plastic pyrolysis oil can also be fed to different locations along riser reactor 73 not shown in FIG. 1A, if desired.

As the cracking reactions occur in riser reactor 73, the waste plastic pyrolysis oil feed and steam feeds are maintained at flow rates sufficient to entrain both the first and second catalysts along with the cracked hydrocarbon products. The reactor effluent stream, including the catalyst mixture, then enters a solid separation device (SSD) 77, which may be used to facilitate concentration of the denser and/or larger second catalyst. SSD 77 may separate the effluent from riser reactor 73 into a vapor/first catalyst stream 79 and a second catalyst stream 81. The second catalyst recovered from the separator may be recycled via flow line 74 back to riser reactor 73 for continued reaction, and as noted above providing for a higher concentration of second catalyst in riser reactor 73.

The cracked hydrocarbons and first catalyst in flow line 79 may then be fed to a disengagement vessel 83 for separating the first catalyst from the cracked hydrocarbon products. The cracked waste-derived hydrocarbon products, including light olefins, C4 hydrocarbons, naphtha range hydrocarbons, and heavier hydrocarbons may be recovered via flow line 49, which may then be separated to recover the desired waste-derived products or product fractions. The first catalyst 12 may then be recovered from disengagement vessel 83 and returned to the catalyst regenerator.

In addition to lift steam 75, a provision may also be made to inject additional waste-derived feed streams, such as C4 olefins or paraffins, naphtha or other external streams as a lift media/reactant. The location of such feed streams may be such that conditions preferential for cracking of the hydrocarbons contained in the respective streams are provided.

While second reactor system 5 is illustrated in FIG. 1A as including a riser reactor, a solids separation device, and a disengagement vessel, other configurations for separating and concentrating the second catalyst within the reactor may be used. Additionally, the reactor of the second reactor system is not limited to a riser reactor. In some embodiments, the second reactor system may include a reactor, such as a bubbling bed or motive bed reactor, where the fluidization is sufficient to carry only the lighter or less dense of the two catalysts out of the reactor, thereby concentrating the second catalyst within the reactor while removing the first catalyst along with the hydrocarbon effluent. The second catalyst, concentrated within the reactor vessel, may be withdrawn, as necessary, for regeneration.

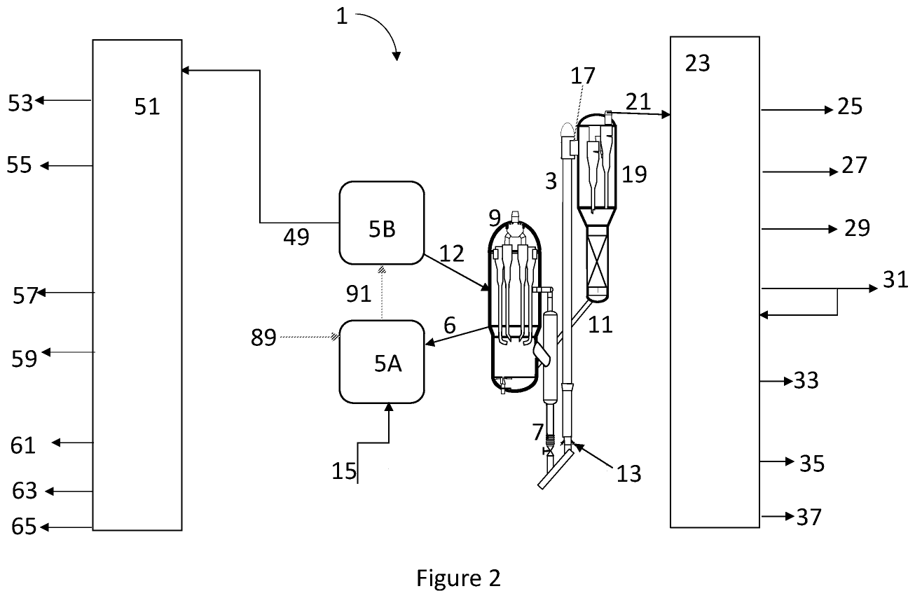

In yet other embodiments, second reactor system 5 may include two or more reactors or reactor systems, such as illustrated in FIG. 2, where like numerals represent like parts. The multiple reactor system 5 may be used, for example, to advantageously pre-treat a contaminant laden waste-derived pyrolysis oil in a first stage reactor or reactor system 5A, and then to further crack the treated waste-derived pyrolysis oil in a second stage reactor or reactor system 5B. Further, the use of the solids separation concepts discussed above may be used to concentrate an additive catalyst, a cracking catalyst, and/or a trapping catalyst within either or both of the first and second stage reactors or reactor systems.

For example, a regenerated catalyst mixture from the catalyst regenerator 9 may be fed to a mixed flow turbulent bed/motive bed reactor 5A. A trapping catalyst 89 may also be fed to mixed flow turbulent bed/motive bed reactor 5A. The trapping catalyst may be formed from particles that are larger and/or more dense than either of the catalysts in the mixed catalyst being fed from the regenerator. The flow regimes in reactor 5A may be maintained such that the trapping catalyst forms a turbulent or bubbling bed, while the regenerated mixed catalysts may form a motive bed, flowing with the hydrocarbons and other fluidizing gases, the mixed catalyst and hydrocarbons being recovered as an effluent 91 from first stage reactor 5A. As necessary, the trapping catalyst may be recovered from reactor system 5A via flow line 93, and may be discarded or may be further processed to recover metals.

Second stage reactor system 5B may be similar to that as described with respect to FIG. 1A, receiving a feed mixture 91 including a mixed catalyst and treated hydrocarbons. The converted products and catalyst recovered as a second reactor effluent may then be fed to an initial separator to recycle the larger/more dense catalyst of the mixed catalysts, allowing concentration of the larger/more dense catalyst within reactor 5B. The converted hydrocarbons and lighter/less dense catalyst may then be separated, returning the spent catalyst 12 back to regenerator 9 and forwarding the waste-derived hydrocarbon products to the fractionation system 51 for processing as described above with respect to FIG. 1.

As illustrated in FIG. 2, the processing scheme integrates pyrolysis oil feed contaminant removal and catalytic processing for light olefins and aromatics production from waste-derived hydrocarbon streams. Such may advantageously allow treatment and processing of a contaminated waste-derived feedstock, and due to the ability to concentrate the various catalysts, including the trapping catalyst, may provide a more efficient and cost-effective means of treating the waste-derived feedstock than prior proposed hydrotreatment systems.

While FIG. 2 is described above as including a three-particle system (mixed cracking catalyst from the regenerator plus trapping catalyst), embodiments herein further contemplate a two particle—two stage reactor system in which an additive rich FCC catalyst and a trapping catalyst are circulated from the regenerator. The resulting contaminant laden catalyst may be recovered from the first stage reactor 5A, while the additive rich FCC catalyst may proceed to second stage reactor 5B along with treated feed vapors. Due to the flexibility of reactor systems herein to operate in multiple flow regimes (turbulent, mixed, and transport), various other combinations of particles/catalysts and concentration of selected particles within a reactor stage are envisioned.

As another example of a process according to FIG. 2, a waste polymeric feedstock may be pyrolyzed to produce a waste plastic pyrolysis oil 15 having a concentration of one or more contaminants, such as iron, calcium, chlorine, or other contaminants. A catalyst mixture may be regenerated in catalyst regenerator 9, the catalyst mixture including a first catalyst and a second catalyst, wherein the second catalyst is configured to trap the one or more contaminants. A first portion of the catalyst mixture may be fed to a first reactor system 3, and a second portion of the catalyst mixture may be fed to a second reactor system 5.

In the first reactor system 3, a fossil-based feedstock may be contacted with the catalyst mixture to crack a portion of the fossil-based feedstock to produce a first effluent 17 comprising fossil-derived olefins, first catalyst, and second catalyst. The first effluent may then be processed similar to that described for FIG. 1, separating the first effluent to recover (i) a mixture of spent first catalyst and spent second catalyst and (ii) a first reactor system product stream comprising fossil-derived olefins and other fossil-derived hydrocarbon products 21.

In the second reactor system, the contaminated waste plastic pyrolysis oil may be contacted with a concentrated catalyst mixture in a first stage reactor to remove contaminants from the waste plastic pyrolysis oil and to crack a portion of the waste plastic pyrolysis oil. The concentrated catalyst mixture may include the portion of the catalyst mixture fed to the second reactor system from the regenerator and additional second catalyst. The catalyst mixture in the first stage reactor may thus have a higher concentration of second catalyst than in the catalyst regenerator 9. Contact of the mixed catalyst within the first stage reactor 5A may produce a first stage reactor effluent comprising a treated waste plastic pyrolysis oil having a reduced contaminant concentration, the first catalyst, and the second catalyst containing trapped contaminants. The first stage reactor effluent may then be separated to produce a first stream 91, comprising the first catalyst and the treated waste plastic pyrolysis oil having a reduced contaminant concentration, and a second stream, comprising the second catalyst. The second stream may then be fed as the additional second catalyst to the second reactor, thereby concentrating the second catalyst (trapping catalyst) within the first stage reactor system. The first stream may then be fed to a second stage reactor to crack the treated waste plastic pyrolysis oil and to recover a second stage reactor effluent comprising spent catalyst and waste-derived olefins and other waste-derived hydrocarbons. The second stage reactor effluent may then be separated to recover (i) spent catalyst and (ii) a second reactor system product stream 49 comprising the waste-derived olefins and other waste-derived hydrocarbons.

Each of (i) the mixture of spent first catalyst and spent second catalyst 11, recovered from reactor system 3, and (ii) the spent catalyst 12, recovered from reactor system 5, may then be fed to the catalyst regenerator for regeneration and continued use in converting hydrocarbons.

As with the system of FIG. 1, it may be desirable to maintain the fossil-based hydrocarbon fractions recovered from the first reactor system 3 separate from the waste-derived hydrocarbon products recovered from the second reactor system 5. In this manner, all products from separation system 51 may be certifiable and correctly accountable as waste-derived products, and which may be used for producing cyclic polymers, for example.

While not illustrated in FIG. 2, processes and systems herein may include feeding one or more hydrocarbon fractions recovered from the waste-derived hydrocarbon products to the first stage reactor 5A of the second reactor system 5. For example, a C4, C5, or light naphtha fraction of full range naphtha may be fed to the first stage reactor 5A, which may operate at conditions preferential for cracking of lighter hydrocarbons.

Further, processes and systems herein also contemplate feeding one or more hydrocarbon fractions recovered from the waste-derived hydrocarbon products to the second stage reactor 5B of the second reactor system. For example, a heavy naphtha fraction or other heavier hydrocarbon fractions may be fed to the second stage reactor 5B, which may operate at conditions preferential for cracking of heavier hydrocarbons.

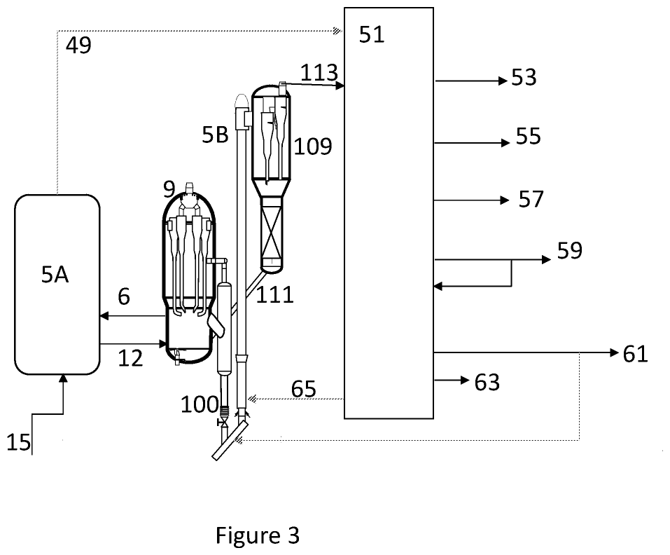

Reaction conditions in each of the reactor systems as described with respect to FIG. 2, and for FIG. 3 as described below, may be similar to those as described with respect to FIG. 1. Regenerator 9, for example, may operate at a temperature in the range from about 600° C. to about 750° C. and a pressure in the range from about 1 barg to about 5 barg. Reactors for converting fossil-based and waste-based hydrocarbon feedstocks may operate at a temperature in the range from about 450° C. to about 750° C. Similarly, the reactor effluents recovered in the embodiments of FIGS. 2 and 3 may be quenched, if desired.

As described above with respect to FIG. 2, the common regenerator may be configured to supply regenerated catalyst to only a first stage reactor of a two-stage reactor system for processing a waste-derived hydrocarbon feedstock. Other embodiments herein contemplate feed of regenerated catalyst to each of the first stage reactor and the second stage reactor of a two-stage reactor system for processing a waste-derived hydrocarbon feedstock. In yet other embodiments, the second stage reactor system of a two-stage reactor system for processing a waste-derived hydrocarbon feedstock may indirectly receive treated feed from the first stage, such as illustrated in FIG. 3.

Referring now to FIG. 3, a simplified process flow diagram of a system for processing waste-derived hydrocarbon feeds is illustrated, where like numerals represent like parts. In some embodiments, the system of FIG. 3 may be used in conjunction with processing of fossil-derived hydrocarbons, similar to that as illustrated in FIGS. 1 and 2, the reactor system 3 not being illustrated in FIG. 3. In other embodiments, the system of FIG. 3 may be used as a stand-alone system for processing waste-derived hydrocarbons (i.e., not integrated with processing of fossil-derived hydrocarbons).

The embodiment of FIG. 3 includes a two-stage reactor system, including a first stage reactor system 5A and a second stage reactor system 5B, each receiving mixed catalyst (6, 100) from the catalyst regenerator 9. The embodiment of FIG. 3 also indirectly provides treated waste-derived hydrocarbons from the first stage reactor system 5A to the second stage reactor system 5B.

As illustrated in FIG. 3, a waste-derived hydrocarbon feed stream 15 may be fed to the first stage reactor system 5A for conversion (cracking) of hydrocarbons therein into lighter hydrocarbons via contact with a mixed catalyst system including a first catalyst and a second catalyst. The system may also include a pyrolysis reactor (not illustrated) for pyrolyzing a waste stream, such as a waste polymeric feedstock, to produce the waste-derived hydrocarbon feed stream 15, such as a waste plastic pyrolysis oil. For example, a catalytic or non-catalytic plastics pyrolysis unit (not illustrated) may be used to pyrolyze a polymeric waste, producing a waste plastic pyrolysis oil stream 15, among other products (not illustrated). Alternatively, a waste plastic pyrolysis oil feedstock 15 may be supplied from a remote source (not illustrated), and may be fed into the conversion unit of FIG. 3 via truck or pipeline, for example. Where the waste-derived hydrocarbon stream 15 is a contaminated waste-derived hydrocarbon stream, in addition to cracking of hydrocarbons in first stage reactor 5A, contaminants may also be removed from the waste-derived hydrocarbons, such as by being captured by the second catalyst, which may be a trapping catalyst.

In the first stage reactor system 5A, the waste-derived hydrocarbon stream 15, such as a waste plastic pyrolysis oil, may be contacted with a concentrated catalyst mixture formed from the regenerated catalyst mixture 6 provided from regenerator 9. Contact with the concentrated catalyst mixture in reactor system 5 may crack a portion of the waste-derived hydrocarbons and remove contaminants to produce a first stage reactor system effluent including waste-derived olefins and other waste-derived hydrocarbons, the first catalyst and the second catalyst.

The concentrated catalyst mixture in the first stage reactor system includes the portion 6 of the catalyst mixture fed to the first stage reactor system 5A from the regenerator 9 and additional second catalyst, the catalyst mixture in the first stage reactor system 5A thus having a higher concentration of second catalyst than in the catalyst regenerator 9. Following conversion in the first stage reactor system 5A and recovery of the effluent, the first stage reactor effluent may be separated to produce a first stream, comprising the first catalyst and the treated waste-derived olefins and other hydrocarbons, and a second stream, comprising the second catalyst. The second stream may then be returned to the first stage reactor system 5A as the additional second catalyst, thereby concentrating the second catalyst within the first stage reactor system.

The first stream, depleted in second catalyst, may be fed to a catalyst separator to recover (i) a spent first catalyst fraction 12 and (ii) a first stage reactor system product stream 49, including the waste-derived olefins and other waste-derived hydrocarbons. The spent catalyst 12 may then be returned to the catalyst regenerator 9 for regeneration and reuse in the reactors.

Following separation of the spent catalyst 12 from the waste-derived hydrocarbon products 49, the waste-derived hydrocarbon products may be forwarded to a fractionation system 51, where the waste-derived hydrocarbons may be fractionated into any number of discrete waste-derived hydrocarbon fractions based on boiling point. As illustrated, the waste-derived hydrocarbon product stream 49 may be fractionated in fractionation system 51 to recover an ethylene-containing fraction 53, a propylene-containing fraction 55, a butene-containing fraction 57, a C5 fraction 59, a naphtha fraction 61, a light cycle oil fraction 63, and a treated pyrolysis oil fraction 65.

Treated waste-derived hydrocarbons may be provided from the fractionation system 51 to the second stage reactor system 5B, which may include a riser reactor, for example. The treated waste derived fractions that may be supplied to the second stage reactor system 5B may include, for example, C4 hydrocarbons 57, C5 hydrocarbons 59, naphtha range hydrocarbons 61A, and/or a treated pyrolysis oil 65, among others.

The treated waste-derived hydrocarbon feedstocks or naphtha/unconverted oil, 61A and 65 as illustrated, may then be contacted with the catalyst mixture 100 in second stage reactor system 5B to crack a portion of the treated waste-based feedstock. An effluent may be recovered from second stage reactor system 5B, the effluent including additional waste-derived olefins (cracked hydrocarbon product), first catalyst, and second catalyst. The effluent from the second stage reactor system 5B may then be forwarded to a separation system 109 for separating the effluent to recover (i) a mixture 111 of spent first catalyst and spent second catalyst and (ii) a second stage reactor system product stream 113 comprising the additional waste-derived olefins and other waste-derived hydrocarbon products resulting from the processing of the treated waste-based hydrocarbon feedstocks 61A, 65. The mixture 111 of spent catalyst may then be returned to the catalyst regenerator 9 for regeneration and reuse in the reactors.

Following separation of the spent catalyst 111 from the treated waste-derived hydrocarbon products 113, the treated waste-derived hydrocarbon products 113 may be forwarded to fractionation system 51 for separation along with the vapor products 49 recovered from the first stage reactor system 5A.

In some embodiments of the process as illustrated in FIG. 3, first stage reactor system 5A may by a catalytic pyrolysis reactor for converting waste polymeric materials to a waste plastic pyrolysis oil. For example, catalytic pyrolysis of a plastic feedstock may be conducted by contacting a plastic feedstock with an appropriate plastic pyrolysis catalyst at an elevated temperature, such as a temperature in the range from 350° C. to 850° C., such as from about 400° C. to about 750° C. In some embodiments, the pyrolysis catalyst may include an individual component or a mixture of spent FCC and/or ZSM-5 catalyst. These catalysts/additives may be modified to provide for a desired purpose, such as reactivity and/or adsorptive capacity toward selected reactants, metals, or contaminants. Pyrolysis of the plastics may produce various hydrocarbons, including light gas hydrocarbon products and liquid hydrocarbon products. The pyrolysis products may then be fed to fractionation system 51 for separation into various hydrocarbon fractions, including the portions used as the waste plastic pyrolysis oil and other waste-based feeds that may be fed to one or more second stage reactor systems 5B, which may include a catalyst-concentrating reactor according to embodiments herein. As noted above, the regenerator providing catalyst to second reactor system 5B may also provide catalyst to a fossil-based reactor system (not illustrated), which may be similar to that as described for reactor system 3 in FIG. 1, for example.

### EXAMPLE 1

This example illustrates the catalytic cracking performance of the reaction systems described herein. Experiments were conducted in a circulating fluidized bed (CFB) pilot plant using a combination of Ultra-Stable Y-zeolite (USY) catalyst along with ZSM-5 additive for converting the pyrolysis oil. The key properties of the feedstocks, derived from conversion of waste plastics processed in a pyrolysis unit, are given in Table 1. Feed A is a naphtha range feed, while Feed B is a blend of naphtha and heavy oil.

The potential of various feedstocks from recycling of waste plastics for maximizing the light olefins was studied. The first set of performance data from the pilot plant experiments reported in Table 2 is corresponding to naphtha feed defined in Table 1, Feed-A, while the second set is corresponding to Feed B. As seen in Table 2, the catalytic cracking of pyrolysis oil feed resulted in a production of very high yield of ethylene, propylene and butylenes. Both types of the feedstocks showed similar results, which demonstrates the potential of these feedstocks to manufacture a true re-circular petrochemical building blocks using processed disclosed herein.

The experimental data also show distinct features of embodiments herein wherein catalyst, process and hardware may be tailored to favor catalytic reactions to maximize light olefins (ethylene, propylene and butylenes) while simultaneously reducing the impact on the eco-system and environmental pollution from waste plastics. This example clearly demonstrates that the catalysts, reactor conditions and mechanisms of cracking these unconventional feeds to light olefins using systems described herein.

TABLE 1
Properties of naphtha and heavy oil derived from
waste plastic pyrolysis process unit.

| Feed Case → | Unit | Case A | Case B |
|---|---|---|---|
| Feed description | | Naphtha boiling | Blend of naphtha |
| | | range oil | boiling range |
| | | | and heavy oil |
| Feed source | | Waste plastics | Waste plastics |
| | | pyrolysis process | pyrolysis process |
| API gravity | — | 48.7 | 45.9 |
| Nitrogen | wppm | 396 | 254 |
| Sulfur | wppm | 34.2 | 32 |
| Metals | wppm | <2 | 18 |
| (Ni + V + Ca + Na + Mg) | | | |
| Chlorine | wppm | 96.8 | 69.2 |
| Distillation data | Deg. F. | | |
| (TBP), wt % | | | |
| IBP | | 113 | 147 |
| 10 | | 258 | 284 |
| 30 | | 342 | 419 |
| 50 | | 422 | 507 |
| 70 | | 491 | 597 |
| 90 | | 595 | 747 |
| 99.5 | | 797 | 1151 |

TABLE 2
Potential of different feedstocks derived from
recycled waste plastics for light olefins production

| Description | Unit | Case A | Case B |
|---|---|---|---|
| Feed type | | Feed A | Feed B |
| Catalyst | | USY + ZSM-5 | USY + ZSM-5 |
| Reactor temperature | Deg. F. | 1100 | 1100 |
| C/O ratio | Wt/wt | 26 | 26 |
| Yields, wt % on fresh feed | Wt % | | |
| Total dry gas (C2-)- | | 12.9 | 13.7 |
| including ethylene | | | |
| Ethylene | | 5.9 | 6.4 |
| Propylene | | 20.4 | 20.9 |
| Butylenes | | 17.1 | 18.5 |
| C5+ liquid product | | 43.0 | 40.3 |
| Coke | | 2.4 | 3.0 |

### EXAMPLE 2

In these experiments, the blend of liquid oil (naphtha range and heavy oil) product from the pyrolysis process unit was subjected to catalytic cracking in presence of a USY and ZSM-5 catalyst blend in a CFB pilot plant at the conditions mentioned below in Table 3. It is evident from the data presented in the Table 3 that increased reactor temperature from 1050° F. to 1100° F. coupled with relatively higher C/O ratios has resulted in higher light olefins (propylene, ethylene and butylenes) yield. Also, at the conditions provided for Case C and Case D, the pyrolysis derived oil shows a higher olefins generation capability, reflecting the preferential conditions for maximizing light olefins.

TABLE 3
Light olefins potential of whole pyrolysis
derived oil at different operating conditions

| Description | Unit | Case C | Case D |
|---|---|---|---|
| Feed | | Feed B | Feed B |
| Catalyst | | USY + ZSM-5 | USY + ZSM-5 |
| Reactor temperature | Deg. F. | 1050 | 1100 |
| C/O ratio | Wt/wt | 25 | 26 |
| Yields, wt % on | Wt % | | |
| fresh feed | | | |
| Total dry gas (C2-)- | | 8.8 | 13.7 |
| including ethylene | | | |
| Ethylene | | 4.4 | 6.4 |
| Propylene | | 20.1 | 20.9 |
| Butylenes | | 18.8 | 18.5 |
| C5+ liquid product | | 45.5 | 40.3 |
| Coke | | 2.6 | 3.0 |

As described above, embodiments herein provide systems and processes that may provide a truly circular solution to plastics recycling. By utilizing a single regenerator dual catalyst (SRDC) reaction system with its own segregated product section while associated with an FCC unit, or a stand-alone on purpose unit integrated with a pyrolysis unit, the resulting products would be 100% circular. Furthermore, because of the characteristics of a fluid bed catalytic reactor, it can be economically sized for receiving product from a pyrolysis units with essentially any capacity, such as, for example, pyrolysis units with a capacity as small as 600 tons/day or greater.

Embodiments herein also serve to address the feedstock acquisition and treatment costs as an economic viability factor. Due to the FCC platform, and more importantly the SRDC platform, systems according to embodiments herein have intrinsic flexibility in regards to feed variation and contaminant content, thus lowering the cost associated with sorting and cleaning.

Selecting the FCC and/or SRDC platform as the pyrolysis oil conversion step in downstream facilities thus addresses the factors listed above regarding the volume and quality requirements of the pyrolysis oil. Embodiments herein, using these platforms, may also eliminate the need for hydroprocessing and hydrotreating and minimizes the impact on the existing operations. The ability of systems herein to concentrate selected catalysts within the reactor systems while using a single regenerator allows processing of the contaminated feedstocks and the varied compositions of waste-derived hydrocarbons, which are much different than typical fossil-based hydrocarbon streams, and provides significant advantages over dilution and steam cracking with fossil-based hydrocarbons, as well as advantages over a FCC system that may include a parallel plastic pyrolysis oil riser reactor.

A further advantage of embodiments herein is with respect to the factor of the revenues from the sale of the products. By utilizing a SRDC unit with its own segregated product section while bolted to an FCC unit, or a stand-alone on purpose unit integrated with a pyrolysis unit, the products would be 100% circular. As the olefins and other valuable products derived from embodiments herein may be 100% circular and concentrated, such products may command a premium, therefore assisting with the economic viability of this recycling route.

Overall, embodiments herein provide for the ability to convert waste plastic pyrolysis oil into valuable products, whether in integration with existing facilities or in an on-purpose dedicated facility, by applying a FCC/SRDC platform. The benefits are derived from (1) feedstock quality flexibility, (2) ability to deal with wider range of composition and potential contaminants without the need to dilute it or comingle it with fossil derived naphtha; (3) ability to produce a segregated product that is 100% circular and commands a premium price; (4) good integration and low impact to the operations of existing downstream facilities;(5) ability to process with economy of scale in an SRDC or FCC unit, both the relatively small amounts of pyrolysis oil generated from currently planned pyrolysis facilities (650 t/d) and those of much larger sizes in the future (greater than 3,000 t/d), while maintaining all of the above described benefits.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed as new and desired to be protected by Letters Patent is:

1. A process for producing raw materials for producing truly circular polymers, the process comprising:
processing a waste plastic pyrolysis oil in a first reactor system with a catalyst mixture;
processing a fossil-based feedstock in a second reactor system with the catalyst mixture;
supplying the catalyst mixture to each of the first and second reactor systems from a common catalyst regenerator;
recovering an effluent comprising fossil-based hydrocarbon products from the second reactor system;
recovering an effluent comprising waste-derived hydrocarbon products from the first reactor system; and
returning spent catalyst from each of the first and second reactor systems to the common catalyst regenerator.

2. The process of claim 1, further comprising maintaining the fossil-based hydrocarbon products recovered from the first reactor system separate from the waste-derived hydrocarbon products recovered from the second reactor system.

3. The process of claim 2, further comprising feeding an olefin fraction recovered from the waste-derived hydrocarbon products to a polymerization system to produce circular polymers.

4. The process of claim 1, further comprising pyrolyzing a waste stream comprising plastics, tires, or other polymeric materials to produce the waste plastic pyrolysis oil.

5. The process of claim 1, further comprising directly or indirectly feeding one or more of the waste-derived hydrocarbon products, or a waste-derived monomer resulting from processing of the waste-derived hydrocarbon products, to a polymerization process to produce a circular polymer.

6. A process for converting waste plastics to feedstock to produce plastics, the process comprising:
pyrolyzing a waste polymeric feedstock to produce a waste plastic pyrolysis oil;
regenerating a catalyst mixture in a catalyst regenerator, the catalyst mixture comprising a first catalyst and a second catalyst;
feeding a portion of the catalyst mixture to a first reactor system;
feeding a portion of the catalyst mixture to a second reactor system;
in the first reactor system, contacting a fossil-based feedstock with the catalyst mixture to crack a portion of the fossil-based feedstock to produce a first effluent comprising fossil-derived olefins, first catalyst, and second catalyst;
in the second reactor system:
contacting the waste plastic pyrolysis oil with a concentrated catalyst mixture in a reactor to crack a portion of the waste plastic pyrolysis oil, wherein the concentrated catalyst mixture comprises the portion of the catalyst mixture fed to the second reactor system and additional second catalyst, the catalyst mixture in the second reactor system thus having a higher concentration of second catalyst than in the catalyst regenerator or the first reactor system, and wherein the contacting produces a second reactor effluent comprising waste-derived olefins and other hydrocarbons, the first catalyst, and the second catalyst;
separating the second reactor effluent to produce a first stream, comprising the first catalyst and the waste-derived olefins and other hydrocarbons, and a second stream, comprising the second catalyst;
feeding the second stream, as the additional second catalyst, to the second reactor, thereby concentrating the second catalyst within the second reactor system;
separating the first effluent to recover (i) a mixture of spent first catalyst and spent second catalyst and (ii) a first reactor system product stream comprising the fossil-derived olefins;
separating the first stream to recover (i) spent first catalyst and (ii) a second reactor system product stream comprising the waste-derived olefins and other waste-derived hydrocarbons; and
feeding to the catalyst regenerator each of (i) the mixture of spent first catalyst and spent second catalyst and (ii) the spent first catalyst.

7. The process of claim 6, wherein the first catalyst comprises one or more selected from the group consisting of amorphous silica alumina, Y-type zeolites, X-type zeolites, zeolite Beta, zeolite MOR, mordenite, faujasite, nano-crystalline zeolites, and MCM mesoporous material.

8. The process of claim 6, wherein the second catalyst comprises one or both of:
an additive type cracking catalyst or a mixture of additive type cracking catalysts selected from the group consisting of Medium Pore Zeolites and pentasil family zeolites; or
a contaminant trapping additive or a mixture of contaminant trapping additives selected from the group consisting of MgO, CaO, CeO₂, MgTiO₃, CaTiO₃, Li₂Ti₂O₇ and ZnTiO₃, Ca/Mg, boron, a rare earth-based trapping additives, or a low chlorine FCC catalyst.

9. The process of claim 6, further comprising:
feeding the first reactor system product stream to a first fractionation system to separate the first reactor system product stream to recover two or more fossil-derived hydrocarbon fractions; and
feeding the second reactor system product stream to a second fractionation system to separate the second reactor system product stream to recover two or more waste-derived hydrocarbon fractions.

10. The process of claim 9, further comprising directly or indirectly feeding one or more of the two or more waste-derived hydrocarbon fractions, or a monomer resulting from processing of one or more of the two or more waste-derived hydrocarbon fractions, to a polymerization process to produce a circular polymer.

11. The process for converting waste plastics to feedstock to produce plastics as claimed in claim 6, wherein:
the pyrolyzing comprises pyrolyzing a waste polymeric feedstock to produce a waste plastic pyrolysis oil having a concentration of one or more contaminants selected from the group consisting of iron, calcium, copper, potassium, magnesium, sodium, silicon, titanium, zinc and chlorine;
the catalyst mixture comprising a first catalyst and a second catalyst comprises a second catalyst configured to trap the one or more contaminants;
the contacting in the second reactor system comprises:
contacting the waste plastic pyrolysis oil with a concentrated catalyst mixture in a first stage reactor to remove contaminants from the waste plastic pyrolysis oil and to crack a portion of the waste plastic pyrolysis oil, wherein the concentrated catalyst mixture comprises the portion of the catalyst mixture fed to the second reactor system and additional second catalyst, the catalyst mixture in the first stage reactor thus having a higher concentration of second catalyst than in the catalyst regenerator, and wherein the contacting produces a first stage reactor effluent comprising a treated waste plastic pyrolysis oil having a reduced contaminant concentration, the first catalyst, and the second catalyst containing trapped contaminants;
separating the first stage reactor effluent to produce a first stream, comprising the first catalyst and the treated waste plastic pyrolysis oil having a reduced contaminant concentration, and a second stream, comprising the second catalyst;
feeding the second stream, as the additional second catalyst, to the first stage reactor, thereby concentrating the second catalyst within the first stage reactor; and
feeding the first stream to a second stage reactor to crack the treated waste plastic pyrolysis oil to recover a second stage reactor effluent comprising spent catalyst and waste-derived olefins and other waste-derived hydrocarbons; and
wherein separating the first stream comprises separating the second stage reactor effluent to recover (i) spent catalyst and (ii) a second stage reactor system product stream comprising the waste-derived olefins and other waste-derived hydrocarbons.

12. The process of claim 11, further comprising maintaining the fossil-based hydrocarbon fractions recovered from the first reactor system separate from the waste-derived hydrocarbon products recovered from the second reactor system.

13. The process of claim 11, further comprising feeding one or more hydrocarbon fractions recovered from the waste-derived hydrocarbon products to the first reactor of the second reactor system.

14. The process of claim 11, further comprising feeding one or more hydrocarbon fractions recovered from the waste-derived hydrocarbon products to the second reactor of the second reactor system.

15. The process of claim 11, further comprising withdrawing a portion of the second catalyst from the first reactor.

16. A process for converting waste plastic materials into monomers for production of circular polymers, the process comprising:
pyrolyzing a waste polymeric feedstock to produce a waste plastic pyrolysis oil having a concentration of one or more contaminants selected from the group consisting of iron, calcium, copper, potassium, magnesium, sodium, silicon, titanium, zinc and chlorine;
regenerating a catalyst mixture in a catalyst regenerator, the catalyst mixture comprising a first catalyst and a second catalyst, wherein the second catalyst is configured to trap the one or more contaminants;
feeding a portion of the catalyst mixture to a first reactor system;
feeding a portion of the catalyst mixture to a second reactor system;
in the first reactor system:
contacting the waste plastic pyrolysis oil with a concentrated catalyst mixture in a first reactor to remove contaminants from the waste plastic pyrolysis oil and to crack a portion of the waste plastic pyrolysis oil, wherein the concentrated catalyst mixture comprises the portion of the catalyst mixture fed to the first reactor system and additional second catalyst, the catalyst mixture in the first reactor system thus having a higher concentration of second catalyst than in the catalyst regenerator, and wherein the contacting produces a first reactor effluent comprising a treated waste plastic pyrolysis oil having a reduced contaminant concentration, the first catalyst, and the second catalyst containing trapped contaminants;
separating the first reactor effluent to produce a first stream, comprising the first catalyst and the treated waste plastic pyrolysis oil having a reduced contaminant concentration, and a second stream, comprising the second catalyst;
feeding the second stream, as the additional second catalyst, to the first reactor, thereby concentrating the second catalyst within the first reactor system; and
feeding the first stream to a separation system to recover a first separation effluent comprising spent first catalyst and a second separation effluent comprising the treated waste plastic pyrolysis oil;
feeding the second separation effluent to a fractionation system to fractionate the treated waste pyrolysis oil into three or more hydrocarbon fractions, including a light olefin fraction, a naphtha fraction, and a treated pyrolysis oil fraction;
feeding at least one of the naphtha fraction and the treated pyrolysis oil fraction to a second reactor system,
in the second reactor system, contacting the at least one of the naphtha fraction and the heavy oil fraction with the catalyst mixture to crack a portion of the hydrocarbons therein to produce a second reactor system effluent comprising waste-derived olefins, first catalyst, and second catalyst;
separating the second reactor system effluent to recover (i) a mixture of spent first catalyst and spent second catalyst and (ii) a second reactor system product stream comprising the waste-derived olefins; and
feeding to the catalyst regenerator each of (i) the mixture of spent first catalyst and spent second catalyst and (ii) the first separation effluent comprising spent first catalyst.

17. A process for producing raw materials for producing truly circular polymers, the process comprising:
processing a waste polymer mixture in a first reactor system comprising a first stage reactor and a second stage reactor, the processing of the waste polymer mixture comprising:
feeding the waste polymer mixture to the first stage reactor to pyrolyze polymers therein and to recover a pyrolyzed effluent;
feeding a waste-derived plastic pyrolysis oil and a catalyst mixture to the second stage reactor to crack hydrocarbons therein and to recover an effluent comprising cracked hydrocarbons;
feeding the pyrolyzed effluent from the first stage reactor and the effluent from the second stage reactor to a first fractionation system to separate the effluents into two or more waste-derived hydrocarbon streams including the waste-derived plastic pyrolysis oil and one or more waste-derived olefin fractions;
processing a fossil-based feedstock in a second reactor system with the catalyst mixture;
supplying the catalyst mixture to each of the first and second reactor systems from a common catalyst regenerator;
recovering an effluent comprising fossil-based hydrocarbon products from the second reactor system;
feeding the effluent comprising fossil-based hydrocarbon products to a second fractionation system; and
returning spent catalyst from each of the first and second reactor systems to the common catalyst regenerator.

18. The process of claim 17, wherein the catalyst mixture comprises a first catalyst and a second catalyst, and wherein the second stage reactor is a catalyst-concentrating reactor system, wherein the process comprises:
recovering a second stage reactor effluent comprising the catalyst mixture and the cracked hydrocarbons;
separating the second stage reactor effluent to produce a first stream, comprising the first catalyst and the cracked hydrocarbons, and a second stream, comprising the second catalyst;
separating the first stream to recover a (i) spent catalyst and (ii) the second stage reactor effluent fed to the first fractionation system; and
feeding the second stream to the second stage reactor, thereby concentrating the second catalyst circulating within the second reactor to a concentration greater than the catalyst mixture as received from the regenerator.

19. The process according to claim 18, wherein the waste polymeric pyrolysis oil is derived from, or wherein the waste polymeric feed or waste polymer mixture comprises: one or more thermoplastics selected from the group consisting of polystyrene, polypropylene, polyphenylene sulfide, polyphenylene oxide, polyethylene, polyetherimide, polyether ether ketone, polyoxymethylene, polyether sulfone, polycarbonate, polybenzimidazole, polylactic acid, nylon, acrylonitrile-butadiene-styrene (ABS) polymers, poly methyl methacrylic acid (PMMA); one or more thermosets formed from monomers including one or more of acrylics, polyesters, vinyl esters, epoxies, urethanes, ureas, and isocyanates; and one or more unsaturated or saturated elastomers selected from the group consisting of polybutadiene, isoprene, chloroprene, styrene-butadiene, nitrile, and ethylene vinyl acetate.

20. A system for producing raw materials for producing truly circular polymers, the system comprising:
a first reactor system containing a catalyst mixture and configured for processing a waste plastic pyrolysis oil;
a second reactor system configured for processing a fossil-based feedstock with the catalyst mixture;
feed lines for supplying the catalyst mixture to each of the first and second reactor systems from a common catalyst regenerator;
a flow line for recovering an effluent comprising fossil-based hydrocarbon products from the second reactor system;
a flow line for recovering an effluent comprising waste-derived hydrocarbon products from the first reactor system; and
flow lines for returning spent catalyst from each of the first and second reactor systems to the common catalyst regenerator.

21. The system of claim 20, further comprising a waste plastic pyrolysis system configured to pyrolyze a waste stream comprising plastics, tires, or other polymeric materials to produce the waste plastic pyrolysis oil.

22. A system for converting waste plastics to feedstock to produce plastics, the system comprising:
a waste plastic pyrolysis reactor system configured for pyrolyzing a waste polymeric feedstock to produce a waste plastic pyrolysis oil;
a catalyst regenerator for regenerating a catalyst mixture, the catalyst mixture comprising a first catalyst and a second catalyst;
a first flow line for feeding a portion of the catalyst mixture from the catalyst regenerator to a first reactor system;
a second flow line for feeding a portion of the catalyst mixture from the catalyst regenerator to a second reactor system;
the first reactor system, configured for contacting a fossil-based feedstock with the catalyst mixture to crack a portion of the fossil-based feedstock to produce a first effluent comprising fossil-derived olefins, first catalyst, and second catalyst;
the second reactor system, configured for:
contacting the waste plastic pyrolysis oil with a concentrated catalyst mixture in a reactor to crack a portion of the waste plastic pyrolysis oil, wherein the concentrated catalyst mixture comprises the portion of the catalyst mixture fed to the second reactor system and additional second catalyst, the catalyst mixture in the second reactor system thus having a higher concentration of second catalyst than in the catalyst regenerator or the first reactor, and wherein the contacting produces a second reactor effluent comprising waste-derived olefins and other hydrocarbons, the first catalyst, and the second catalyst;
separating the second reactor effluent to produce a first stream, comprising the first catalyst and the waste-derived olefins and other hydrocarbons, and a second stream, comprising the second catalyst;
feeding the second stream, as the additional second catalyst, to the second reactor, thereby concentrating the second catalyst within the second reactor system;
a first separation system for separating the first effluent to recover (i) a mixture of spent first catalyst and spent second catalyst and (ii) a first reactor system product stream comprising the fossil-derived olefins;
a separation system for separating the first stream to recover (i) spent first catalyst and (ii) a second reactor system product stream comprising the waste-derived olefins and other hydrocarbons; and
flow lines configured for feeding to the catalyst regenerator each of (i) the mixture of spent first catalyst and spent second catalyst and (ii) the spent first catalyst.

23. The system of claim 22, further comprising:
a first fractionation system configured to separate the first reactor system product stream to recover two or more fossil-derived hydrocarbon fractions; and
a second fractionation system configured to separate the second reactor system product stream to recover two or more waste-derived hydrocarbon fractions.

24. The system of claim 23, further comprising a polymerization system configured to directly or indirectly receive one or more of the two or more waste-derived hydrocarbon fractions, or a monomer resulting from processing of one or more of the two or more waste-derived hydrocarbon fractions, to produce a circular polymer.

25. A system for converting waste plastics to feedstock to produce plastics, the system comprising:
a pyrolysis reactor system for pyrolyzing a waste polymeric feedstock to produce a waste plastic pyrolysis oil having a concentration of one or more contaminants selected from the group consisting of iron, calcium, copper, potassium, magnesium, sodium, silicon, titanium, zinc and chlorine;
a catalyst regenerator for regenerating a catalyst mixture, the catalyst mixture comprising a first catalyst and a second catalyst, wherein the second catalyst is configured to trap the one or more contaminants;
a flow line for feeding a portion of the catalyst mixture from the catalyst regenerator to a first reactor system;
a flow line for feeding a portion of the catalyst mixture from the catalyst regenerator to a second reactor system;
the first reactor system, configured for contacting a fossil-based feedstock with the catalyst mixture to crack a portion of the fossil-based feedstock to produce a first effluent comprising fossil-derived olefins, first catalyst, and second catalyst;
the second reactor system, configured for:
contacting the waste plastic pyrolysis oil with a concentrated catalyst mixture in a first stage reactor to remove contaminants from the waste plastic pyrolysis oil and to crack a portion of the waste plastic pyrolysis oil, wherein the concentrated catalyst mixture comprises the portion of the catalyst mixture fed to the second reactor system and additional second catalyst, the catalyst mixture in the first stage reactor thus having a higher concentration of second catalyst than in the catalyst regenerator, and wherein the contacting produces a first stage reactor effluent comprising a treated waste plastic pyrolysis oil having a reduced contaminant concentration, the first catalyst, and the second catalyst containing trapped contaminants;
separating the first stage reactor effluent to produce a first stream, comprising the first catalyst and the treated waste plastic pyrolysis oil having a reduced contaminant concentration, and a second stream, comprising the second catalyst;
feeding the second stream, as the additional second catalyst, to the first stage reactor, thereby concentrating the second catalyst within the first stage reactor; and
feeding the first stream to a second stage reactor to crack the treated waste plastic pyrolysis oil to recover a second stage reactor effluent comprising spent catalyst and waste-derived olefins and other waste-derived hydrocarbons;
a first separation system configured for separating the first effluent to recover (i) a mixture of spent first catalyst and spent second catalyst and (ii) a first reactor system product stream comprising the fossil-derived olefins;
a second separation system configured for separating the second stage reactor effluent to recover (i) spent catalyst and (ii) a second stage reactor system product stream comprising the waste-derived olefins and other waste-derived hydrocarbons; and
flow lines for feeding to the catalyst regenerator each of (i) the mixture of spent first catalyst and spent second catalyst and (ii) the spent catalyst.

26. The system of claim 25, further comprising:
a first fractionation system to separate the first reactor system product stream to recover two or more fossil-derived hydrocarbon fractions; and
a second fractionation system to separate the second stage reactor system product stream and to recover two or more waste-derived hydrocarbon fractions.

27. The system of claim 26, configured for maintaining the fossil-based hydrocarbon fractions recovered from the first reactor system separate from the waste-derived hydrocarbon products recovered from the second reactor system.

28. The system of claim 26, further comprising a polymerization configured to directly or indirectly receive a monomer recovered or derived from the waste-derived hydrocarbon products to produce circular polymers.

29. The system of claim 26, further comprising a flow line for feeding one or more hydrocarbon fractions recovered from the waste-derived hydrocarbon products to the first reactor of the second reactor system.

30. The system of claim 26, further comprising a flow line for feeding one or more hydrocarbon fractions recovered from the waste-derived hydrocarbon products to the second reactor of the second reactor system.

31. The process of claim 26, further comprising a flow line for withdrawing a portion of the second catalyst from the first reactor.

32. A system for converting waste plastic materials into circular polymers, the system comprising:
a waste plastic pyrolysis reactor for pyrolyzing a waste polymeric feedstock to produce a waste plastic pyrolysis oil having a concentration of one or more contaminants selected from the group consisting of iron, calcium, copper, potassium, magnesium, sodium, silicon, titanium, zinc and chlorine;
a catalyst regenerator for regenerating a catalyst mixture, the catalyst mixture comprising a first catalyst and a second catalyst, wherein the second catalyst is configured to trap the one or more contaminants;
a flow line for feeding a portion of the catalyst mixture to a first reactor system;
a flow line for feeding a portion of the catalyst mixture to a second reactor system;
the first reactor system, configured for:
contacting the waste plastic pyrolysis oil with a concentrated catalyst mixture in a first reactor to remove contaminants from the waste plastic pyrolysis oil and to crack a portion of the waste plastic pyrolysis oil, wherein the concentrated catalyst mixture comprises the portion of the catalyst mixture fed to the first reactor system and additional second catalyst, the catalyst mixture in the first reactor system thus having a higher concentration of second catalyst than in the catalyst regenerator, and wherein the contacting produces a first reactor effluent comprising a treated waste plastic pyrolysis oil having a reduced contaminant concentration, the first catalyst, and the second catalyst containing trapped contaminants;
separating the first reactor effluent to produce a first stream, comprising the first catalyst and the treated waste plastic pyrolysis oil having a reduced contaminant concentration, and a second stream, comprising the second catalyst;
feeding the second stream, as the additional second catalyst, to the first reactor, thereby concentrating the second catalyst within the first reactor system; and
a separation system to recover a first separation effluent comprising spent first catalyst and a second separation effluent comprising the treated waste plastic pyrolysis oil;
a fractionation system to fractionate the treated waste pyrolysis oil into three or more hydrocarbon fractions, including a light olefin fraction, a naphtha fraction, and a treated pyrolysis oil fraction;
a flow line for feeding at least one of the naphtha fraction and the treated pyrolysis oil fraction to a second reactor system, the second reactor system, configured for contacting the at least one of the naphtha fraction and the heavy oil fraction with the catalyst mixture to crack a portion of the hydrocarbons therein to produce a second reactor system effluent comprising waste-derived olefins, first catalyst, and second catalyst;
a separation system configured for separating the second reactor system effluent to recover (i) a mixture of spent first catalyst and spent second catalyst and (ii) a second reactor system product stream comprising the waste-derived olefins; and
flow lines for feeding to the catalyst regenerator each of (i) the mixture of spent first catalyst and spent second catalyst and (ii) the first separation effluent comprising spent first catalyst.

33. A system for producing raw materials for producing truly circular polymers, the system comprising:
a first reactor system comprising a first stage reactor and a second stage reactor, configured for:
feeding the waste polymer mixture to the first stage reactor to pyrolyze polymers therein and to recover a pyrolyzed effluent;
feeding a waste-derived plastic pyrolysis oil and a catalyst mixture to the second stage reactor to crack hydrocarbons therein and to recover an effluent comprising cracked hydrocarbons;
feeding the pyrolyzed effluent from the first stage reactor and the effluent from the second stage reactor to a first fractionation system to separate the effluents into two or more waste-derived hydrocarbon streams including the waste-derived plastic pyrolysis oil and one or more waste-derived olefin fractions;
a second reactor system configured for processing a fossil-based feedstock with the catalyst mixture;
a common catalyst regenerator configured for supplying the catalyst mixture to each of the first and second reactor systems;
a flow line for recovering an effluent comprising fossil-based hydrocarbon products from the second reactor system;
a second fractionation system for separating the effluent comprising fossil-based hydrocarbon products; and
flow lines for returning spent catalyst from each of the first and second reactor systems to the common catalyst regenerator.

34. The system of claim 33, wherein the catalyst mixture comprises a first catalyst and a second catalyst, and wherein the second stage reactor is a catalyst-concentrating reactor system.
